(19) United States
(12) Patent Application Publication
(10) Pub. No.: US 2026/0161814 A1
(43) Pub. Date: Jun. 11, 2026

(54) ELECTRONIC DEVICE FOR PROVIDING VIRTUAL ENVIRONMENT FOR GENERATING SYNTHETIC DATA, OPERATION METHOD OF ELECTRONIC DEVICE, AND SYSTEM COMPRISING ELECTRONIC DEVICE

(71) Applicant: Pebblous Inc., Daejeon (KR)

(72) Inventors: Joo Haeng Lee, Sejong-si (KR); Jeong Won Lee, Daejeon (KR)

(21) Appl. No.: 19/178,744

(22) Filed: Apr. 14, 2025

Related U.S. Application Data
(63) Continuation of application No. PCT/KR2023/015898, filed on Oct. 16, 2023.

(30) Foreign Application Priority Data
Oct. 18, 2022 (KR) 10-2022-0133779
Oct. 18, 2022 (KR) 10-2022-0133780
Oct. 18, 2022 (KR) 10-2022-0133781
Mar. 28, 2023 (KR) 10-2023-0040247
Mar. 28, 2023 (KR) 10-2023-0040248
Mar. 28, 2023 (KR) 10-2023-0040249

(51) Int. Cl. G06F 21/62; G06F 16/25

(52) U.S. Cl. CPC G06F 21/6218; G06F 16/256

(57) ABSTRACT

A method for providing a virtual environment in which at least one data provider terminal can generate data, the method comprising, by at least one processor of an electronic device: obtaining a request for generation of a data set; identifying a reference data set pre-stored in a memory based on the obtained request; obtaining first request information including a first generation condition which is set based on a relationship with the reference data set, and providing a first virtual environment for data generation based on the first request information; determining whether a first synthesized data set, generated by at least one user terminal accessing the first virtual environment, satisfies the first generation condition; and blocking user access to the first virtual environment based on a determination that the first synthesized data set satisfies the first generation condition.

### CROSS-REFERENCE TO RELATED APPLICATIONS

This application is a bypass continuation of International Application No. PCT/KR2023/015898, filed on Oct. 16, 2023, which is based on and claims priority to Korean Patent Application No. 10-2022-0133779, filed on Oct. 18, 2022, Korean Patent Application No. 10-2022-0133780, filed on Oct. 18, 2022, Korean Patent Application No. 10-2022-0133781, filed on Oct. 18, 2022, and Korean Patent Application No. 10-2023-0040247, filed on Mar. 28, 2023, Korean Patent Application No. 10-2023-0040248, filed on Mar. 28, 2023 and Korean Patent Application No. 10-2023-0040249, filed on Mar. 28, 2023 in the Korean Intellectual Property Office, the disclosures of which are incorporated by reference herein in their entireties.

### BACKGROUND

### Technical Field

The present disclosure relates to an electronic device (or computing device) that provides an integrated data platform equipped with various data-related functions in a virtual environment.

### Background Art

With advances in AI technology, research on AI models has become active. Beyond model architecture, training data are crucial for AI learning. Consequently, intensive research is under way on synthesized (virtual) data—i.e., synthetic data generated by specific methods rather than collected as real-world data—to secure large volumes of high-quality training data.

Because data collection has become paramount, platforms for generating large-scale data are emerging. Current platforms, however, rely on crowdsourcing; each data provider must secure data independently, and no environment is offered in which providers can directly generate data.

As the asset value of data increases, data trading is becoming active. Because data are intangible assets transacted via networks, security and reliability are paramount. When trading is handled through a centralized network, however, ownership records are stored centrally, making robust transaction security difficult. In addition, data demanders must manually search for data having desired attributes, causing inefficiencies in the trading process.

The present disclosure provides a virtual-environment platform that resolves the above-described problems in data-generation and data-trading environments.

### SUMMARY

### Technical Problem

A first technical problem addressed by the disclosure is to provide an environment capable of generating data that match a demander's requirements.

Another technical problem is to provide an environment in which data can be transacted securely.

These problems are not exhaustive; other objectives will be apparent to those skilled in the art from the specification and drawings.

### Technical Solution

According to one embodiment of the present disclosure, there is provided a method for providing a virtual environment in which at least one data provider terminal can generate data, the method comprising, by at least one processor of an electronic device: obtaining a request for generation of a data set; identifying a reference data set pre-stored in a memory based on the obtained request; obtaining first request information including a first generation condition which is set based on a relationship with the reference data set, and providing a first virtual environment for data generation based on the first request information; determining whether a first synthesized data set, generated by at least one user terminal accessing the first virtual environment, satisfies the first generation condition; and blocking user access to the first virtual environment based on a determination that the first synthesized data set satisfies the first generation condition.

According to another embodiment of the present disclosure, there is provided a method for performing data transactions in a virtual environment, the method comprising, by at least one processor of an electronic device: obtaining a first sub-data set from a first user terminal and obtaining a second sub-data set from a second user terminal; obtaining a first data set that includes the first sub-data set and the second sub-data set; obtaining contribution information reflecting the contributions of the first user terminal and the second user terminal, based on the first sub-data set and the second sub-data set; obtaining first block data based on the first data set and the contribution information; obtaining second block data based on a transaction agreement corresponding to the first data set; and distributing a first reward, generated by the transaction agreement, to the first user terminal and the second user terminal based on the contribution information.

According to one embodiment of the present disclosure, there is provided a method of operating an electronic device for optimizing an AI model, the method comprising, by at least one processor of the electronic device: constructing a virtual environment; providing at least one data generation tool to at least one user terminal accessing the constructed virtual environment; obtaining a first synthesized data set using the at least one data generation tool; training a reference model stored in the memory of the electronic device based on the first synthesized data set; inputting a first evaluation data set into the trained reference model; and, if an output result from the reference model based on the first evaluation data set does not satisfy a predetermined criterion, providing feedback to the at least one user terminal, wherein the feedback is configured to request creation of data associated with the first evaluation data set.

According to various embodiments, the technical solutions and their effects thereof are not limited to those mentioned solutions above. The solutions and effects that are not mentioned may be clear to those skilled in the art with reference to the following detailed description and the accompanying drawings.

### Advantageous Effects

Embodiments of the disclosure can provide an electronic device that provides an environment for generating data matching demander requirements,

Further, embodiments of the disclosure provide an electronic device that provides an environment for securely trading data.

The effects of the embodiments included in this disclosure are not limited to those described above, and those not described will be apparent to one having ordinary skill in the art from this description and the accompanying drawings.

### BRIEF DESCRIPTION OF THE DRAWINGS

FIG. 1 is a diagram illustrating a system for providing a data platform according to various embodiments.

FIG. 2 is a diagram illustrating a hardware configuration of an electronic device (for example, a platform providing device or a server and/or administrator terminal included in the platform providing device) according to various embodiments.

FIG. 3 is a diagram illustrating various environments provided in a data platform environment offered by an electronic device according to various embodiments.

FIG. 4 is a diagram illustrating hardware configurations of an electronic device (for example, a user terminal such as a mobile phone or PC) according to various embodiments.

FIG. 5 is a diagram illustrating examples in which a data platform environment is implemented by an electronic device according to various embodiments.

FIG. 6 is a diagram illustrating operations performed by an electronic device in a data platform environment according to various embodiments.

FIG. 7 is a diagram for explaining information that an electronic device may generate or receive and store in memory, according to various embodiments.

FIG. 8 is a flowchart illustrating a method by which at least one electronic device generates a data set, according to various embodiments.

FIG. 9 is a diagram exemplarily illustrating a method by which at least one electronic device generates a data set, according to various embodiments.

FIG. 10 is a diagram illustrating an operation in which an electronic device updates the information of a project for data generation, according to various embodiments.

FIG. 11 is a diagram illustrating a method by which an electronic device provides a data image to perform a data generation operation, according to various embodiments.

FIG. 12 is a diagram illustrating a user interface through which an electronic device generates data using a data generation tool, according to various embodiments.

FIG. 13 is a flowchart illustrating a method by which the electronic device provides generated data in a visualized form, according to various embodiments.

FIG. 14 is a diagram illustrating a user interface in which the electronic device provides generated data in a visualized form, according to various embodiments.

FIG. 15 is a flowchart for explaining additional information that an electronic device can provide related to data generation, according to various embodiments.

FIG. 16 is a diagram illustrating one embodiment of a user interface in which the electronic device provides additional information related to data generation, according to various embodiments.

FIG. 17 is a diagram illustrating another embodiment of a user interface in which the electronic device provides additional information related to data generation, according to various embodiments.

FIG. 18 is a diagram describing functions by which an electronic device can provide a data transaction environment, according to various embodiments.

FIG. 19 is a schematic diagram illustrating a method by which an electronic device provides a data transaction environment, according to various embodiments.

FIG. 20 is a flowchart illustrating a method by which an electronic device conducts transactions involving a synthesized data set—acquired from a supplier terminal—using a blockchain network, according to various embodiments.

FIG. 21 is a diagram illustrating the information stored in a blockchain network as the electronic device transacts a synthesized data set acquired from a supplier terminal, according to various embodiments.

FIG. 22 is a flowchart illustrating a method by which an electronic device provides a data transaction environment based on a smart contract, according to various embodiments.

FIG. 23 is a diagram illustrating how block data is generated in a data transaction based on a smart contract, according to various embodiments.

FIG. 24 is a diagram illustrating a general method by which an electronic device can obtain contribution information, according to various embodiments.

FIG. 25 is a diagram illustrating a method by which an electronic device acquires contribution information based on quality information, according to various embodiments.

FIG. 26 is a diagram illustrating a method by which an electronic device generates quality information about a created data set, according to various embodiments.

FIG. 27 is a flowchart illustrating a method by which an electronic device acquires platform contribution information, according to various embodiments.

FIG. 28 is a diagram illustrating a data improvement method of an electronic device that provides a platform, according to various embodiments.

FIG. 29 is a diagram illustrating how an electronic device that provides a platform may acquire platform contribution information through the process of improving data, according to various embodiments.

FIG. 30 is a diagram illustrating a method by which an electronic device provides feedback on data generation using a reference model, according to various embodiments.

FIG. 31 is a diagram illustrating a method by which an electronic device trains and demonstrates a waste-plastic classification model, according to various embodiments.

FIG. 32 is a flowchart illustrating a data-construction method for training a model that detects outlier data, according to various embodiments.

FIG. 33 is a diagram illustrating a method by which an electronic device demonstrates an outlier-detection model, according to various embodiments.

### DETAILED DESCRIPTION OF THE INVENTION

Hereinafter, the embodiments of the present disclosure will be described in detail with reference to the accompanying drawings. In describing the embodiments, technical details that are well-known to those skilled in the art and are not directly related to the present disclosure will be omitted. This is to clearly describe the subject matter of the present disclosure by omitting redundant descriptions.

The embodiments presented in this specification are intended to clearly describe the spirit of the present invention to those of ordinary skill in the relevant art. The present invention is not limited to the embodiments described herein, and the scope of the present invention should be interpreted to encompass modifications or variations that do not depart from its spirit of the present invention.

Although the terminology used in this specification includes as general terms currently widely accepted for describing the functions in the present invention, interpretations of these terms may vary depending on the intentions of practitioners in the relevant field, precedents, or emerging technologies. In a case where a specific term is defined and used with different meanings, the specific meaning will be explicitly provided. Therefore, the terms used herein should be interpreted based on the substantive meaning and the overall context of this specification rather than their mere literal meaning.

The accompanying drawings are intended to easily describe the present invention, and the shapes depicted in the drawings may be exaggerated as necessary to aid understanding of the present invention. Thus, the scope of the present invention is not limited by the depictions in the drawings.

Where it is judged that a detailed description of publicly known constructions or functions related to the present disclosure may obscure the gist of the present disclosure, such detailed description may be omitted as necessary. Moreover, any numbers (for example, “first,” “second,” etc.) used in this specification are merely identifiers for distinguishing one component from another.

Furthermore, suffixes such as “part” or “unit,” used with respect to components in the description below, are employed simply to facilitate explanation and may be used interchangeably. They are not intended to imply any distinction in meaning or function among the components themselves.

In other words, the embodiments of the disclosure are provided to make the disclosure complete and to give one of ordinary skill in the art to which the disclosure belongs a sense of the scope of the disclosure, and the invention of the disclosure is defined only by the scope of the claims. Throughout the specification, like reference numerals refer to like components.

The terms “first” and “second” may be used to describe various components, but these terms are only for differentiation purposes. The above terms are used only for the purpose of distinguishing one component from another, e.g. a first component may be named as a second component, and similarly a second component may be named as a first component, without departing from the scope of the rights according to the concepts of the present disclosure.

It should be understood that when an element is described as being “connected” or “coupled” to another element, there may be intervening elements in between or it may be directly connected or coupled to the other element. On the other hand, when an element is described as being “directly connected” or “directly coupled” to another element, it should be understood that there are no intervening elements. Other expressions that describe the relationship between elements (i.e., “between” and “immediately between”, “neighboring to” and “directly neighboring to”, or “adjacent to” and “directly adjacent to”) should be interpreted similarly.

In the drawings, each block of the flowcharts and combinations of the flowcharts may be performed by computer program instructions. Since these computer program instructions may be incorporated into a processor of a general-purpose computer, special purpose computer, or other programmable data processing apparatus, the instructions executed by the processor of the computer or other programmable data processing apparatus create means for performing the functions described in the flowchart block(s). Since these computer program instructions may be stored in a computer-usable or computer-readable memory that can direct a computer or other programmable data processing apparatus to implement a function in a particular manner, the instructions stored in the computer-usable or computer-readable memory can produce articles of manufacture that include instructions for means to perform the functions described in the flowchart block(s). Since the computer program instructions may be mounted on a computer or other programmable data processing apparatus, a series of operational steps may be performed on the computer or other programmable data processing apparatus to produce a computer-executed process, and the instructions for the computer or other programmable data processing apparatus may provide steps for performing the functions described in the flowchart block(s).

Each block may represent a module, segment, or portion of code including one or more executable instructions designed to perform a specified logical function. It should be noted that in some embodiments, the functions mentioned in the blocks may occur in a different order than described. For example, two blocks shown in succession may be performed concurrently, simultaneously or in reverse order, depending on the functions they represent. For example, operations performed by a module, program, or other component may be executed sequentially, in parallel, repeatedly, or heuristically; one or more of the operations may be executed in a different order, omitted, or one or more other operations may be added.

The term “unit” used in this specification refers to software or hardware components such as Field Programmable Gate Array (FPGA) or Application Specific Integrated Circuit (ASIC). The “unit” performs specific roles but is not limited to software or hardware. The “unit” may be configured to reside in an addressable storage medium or to reproduce one or more processors. Accordingly, in some embodiments, the “unit” includes components such as software components, object-oriented software components, class components, processes, functions, attributes, procedures, subroutines, segments of program code, drivers, firmware, microcode, circuits, data, databases, data structures, tables, arrays, and variables. The functions provided in the components and “units” may be combined into fewer components and “units,” or it may be disseminated into additional components and “units.” These components and “units” may be implemented to reproduce one or more CPUs within a device or a secure multimedia card. Additionally, according to various embodiments of the present disclosure, the “units” may include one or more processors.

Hereinafter, the operational principles of the present disclosure will be described in detail with reference to the accompanying drawings. In describing the present disclosure below, detailed descriptions of well-known functions or configurations may be omitted if they are deemed to unnecessarily obscure the spirit of the present disclosure. Additionally, the terminology described below is defined in consideration of the functions of the present disclosure and may vary depending on the intent of users or operators, or on practice. Accordingly, the definitions should be derived based on the overall content of this specification.

According to one embodiment of the present disclosure, there is provided a method for providing a virtual environment in which at least one data provider terminal can generate data, the method comprising, by at least one processor of an electronic device: obtaining a request for generation of a data set; identifying a reference data set pre-stored in a memory based on the obtained request; obtaining first request information including a first generation condition which is set based on a relationship with the reference data set, and providing a first virtual environment for data generation based on the first request information; determining whether a first synthesized data set, generated by at least one user terminal accessing the first virtual environment, satisfies the first generation condition; and blocking user access to the first virtual environment based on a determination that the first synthesized data set satisfies the first generation condition.

In addition, the request may include at least one of properties(or attributes) of the data set—wherein the properties of the data set include a domain of the data and a modality of the data—quality of the data set, or sample data.

In addition, identifying the reference data set may include searching, among a plurality of reference data sets pre-stored in the memory, for a reference data set corresponding to the request.

In addition, the first generation condition may be established based on a similarity with the reference data set.

In addition, the first request information may include the first generation condition, the reference data set, and the sample data.

In addition, after providing the first virtual environment, the method may further include obtaining level information, which indicates the level of data to be generated based on the first request information; selecting a first data provider corresponding to the level information based on the level information; and providing information about the first virtual environment to a first user terminal corresponding to the selected first data provider.

In addition, determining whether the first generation condition is satisfied may include checking a similarity between the first synthesized data set and the reference data set, and determining whether the similarity corresponds to the first generation condition.

In addition, the method may further include obtaining a second generation condition established based on a relationship with the reference data set, wherein the first generation condition is established based on a first correlation with the reference data set, and the second generation condition is established based on a second correlation with the reference data set.

In addition, the method may further include providing the first generation condition to a second user terminal accessing the first virtual environment, and providing the second generation condition to a third user terminal accessing the first virtual environment.

In addition, based on a determination that the first synthesized data set does not satisfy the first generation condition, the method may further include requesting additional data generation from the at least one user terminal.

In addition, the method may further include obtaining an improved synthesized data set based on a second synthesized data set additionally generated by the at least one user terminal.

In addition, providing the first virtual environment may include selecting some of a plurality of data generation tools stored in the memory, based on the first request information.

In addition, blocking user access to the first virtual environment may include storing the first synthesized data set in the memory.

According to another embodiment of the present disclosure, there is provided a method for performing data transactions in a virtual environment, the method comprising, by at least one processor of an electronic device: obtaining a first sub-data set from a first user terminal and obtaining a second sub-data set from a second user terminal; obtaining a first data set that includes the first sub-data set and the second sub-data set; obtaining contribution information reflecting the contributions of the first user terminal and the second user terminal, based on the first sub-data set and the second sub-data set; obtaining first block data based on the first data set and the contribution information; obtaining second block data based on a transaction agreement corresponding to the first data set; and distributing a first reward, generated by the transaction agreement, to the first user terminal and the second user terminal based on the contribution information.

In addition, the first block data may include first transaction information that includes information related to the creation of the first data set. The first transaction information may include ownership information indicating an owner of the first data set, share information indicating the share ratio among multiple co-owners of the first data set, and reward information reflecting a second reward generated by creation of the first data set.

In addition, the ownership information may include information about the current owner of the first data set and information about previous owners.

In addition, the share information may be obtained based on the contribution information, wherein the share ratio of the first user terminal and the share ratio of the second user terminal may be calculated based on the contributions of the first user terminal and the second user terminal, as identified via the contribution information.

In addition, the transaction agreement may include an operation of checking a transaction request received from a third user terminal and, in response to the transaction request, providing an approval intent to the third user terminal.

In addition, the transaction agreement may include an operation of checking a transaction proposal received from a third user terminal and, in response to the transaction request, providing an approval intent to the third user terminal.

In addition, the transaction agreement may include an operation of sending a transaction proposal for the first data set to a third user terminal and an operation of receiving an approval intent from the third user terminal with respect to the transaction proposal.

In addition, the second block data may include second transaction information that contains information related to a transaction of the first data set. The second transaction information may include owner change information indicating changes in ownership due to the transaction, and reward information including the first reward that accompanies the transaction.

In addition, distributing to the first user terminal and the second user terminal may include distributing the first reward based on the share ratio of the first user terminal and the share ratio of the second user terminal, as identified by the share information.

In addition, the contribution information may include platform contribution information obtained based on the extent to which at least one tool provided in the virtual environment is used in creating the first data set.

In addition, the at least one tool may include a data generation tool used to create synthesized data and a quality evaluation tool used to assess the quality of the data.

In addition, the method may further include transmitting the first block data and the second block data to a blockchain network.

According to one embodiment of the present disclosure, there is provided a method of operating an electronic device for optimizing an AI model, the method comprising, by at least one processor of the electronic device: constructing a virtual environment; providing at least one data generation tool to at least one user terminal accessing the constructed virtual environment; obtaining a first synthesized data set using the at least one data generation tool; training a reference model stored in the memory of the electronic device based on the first synthesized data set; inputting a first evaluation data set into the trained reference model; and, if an output result from the reference model based on the first evaluation data set does not satisfy a predetermined criterion, providing feedback to the at least one user terminal, wherein the feedback is configured to request creation of data associated with the first evaluation data set.

In addition, the feedback may include a range of generation parameters for creating data associated with the first evaluation data set, wherein the generation parameters are used by the data generation tool to generate synthesized data.

In addition, the feedback may include a message requesting creation of data associated with the first evaluation data set.

In addition, the first evaluation data set may be provided by a first user terminal that is not permitted to access the virtual environment.

In addition, the method may further include retraining the reference model based on a second synthesized data set generated according to the feedback.

In addition, the method may further include inputting a second evaluation data set into the retrained reference model; and, if an output result from the reference model based on the second evaluation data set satisfies the predetermined criterion, storing the second synthesized data set in the memory.

In addition, the reference model may be configured to determine whether a plastic is recyclable.

In addition, the evaluation data set may include first plastic data associated with recyclable plastic, and the at least one processor may be configured, according to an output result from the reference model, to request creation of data associated with the first plastic data from the at least one user terminal if the first plastic data is not determined to be recyclable.

In addition, the evaluation data set may include second plastic data associated with recyclable plastic, and the at least one processor may be configured, according to an output result from the reference model, to provide a visual effect to the second plastic data if the second plastic data is determined to be recyclable.

Hereinafter, an electronic device providing a virtual environment platform that includes various functions associated with the data disclosed herein, a method of operating the electronic device, and a system including the electronic device will be described.

### System

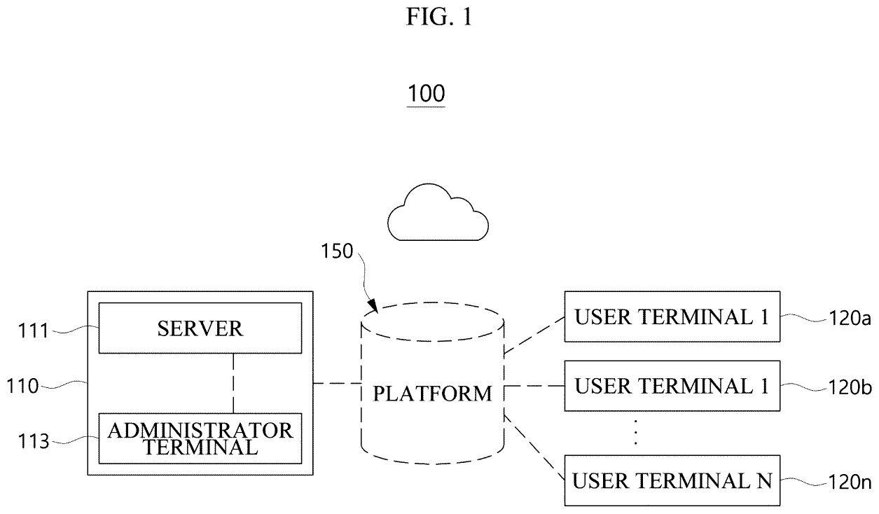

FIG. 1 is a diagram illustrating a system for providing a data platform according to various embodiments.

A system for providing a data platform may implement a platform environment that enables users to generate data (for example, synthetic data), conduct transactions involving data, or receive various experiences leveraging the data. In addition, an electronic device that provides the data platform (e.g., a server or an administrator terminal) may build a data asset storage by converting various forms of data obtained from users of the platform environment into assets and storing them (for example, synthetic data or data associated with the generation and transaction of data).

Referring to FIG. 1, a system 100 for providing a data platform may include a platform providing device 110 and at least one user terminal (120a, 120b, . . . , 120n) that uses a data platform environment 150 constructed by the platform providing device. In addition, if communication connectivity is established via a communication network (Net), the platform providing device 110 and the at least one user terminal (120a, 120b, . . . , 120n) may transmit and receive data to and from each other.

The platform providing device 110 may provide a data platform environment 150. In this context, the data platform environment 150 may be a virtual environment for providing various functions and services associated with data, such as generating, transacting, or utilizing data.

The platform providing device 110 may include a server 111 and at least one administrator terminal 113 that manages the server. Specifically, through the at least one administrator terminal 113, various platform environments provided by the server 111 may be managed. Moreover, the administrator terminal 113 may play a particular role in those various platform environments (for example, a “producer” who designs projects for data generation). Furthermore, not limited thereto, at least one user terminal may also take on specific roles in various platform environments (for example, a “creator” who participates in a project to generate data, or a “consumer” who demands data). Here, the concept of a “role” in the present disclosure is merely assigned arbitrarily according to the purpose of a given subject, and is not intended to limit the invention based on the name or number of roles.

In addition, the platform providing device 110 may provide the data platform environment 150 by constructing a virtual environment (or virtual space) that can be used by at least one user terminal. In the present disclosure, the term “virtual environment” encompasses, for instance, virtual or augmented reality environments accessible via AR or VR devices, as well as virtual spaces on the internet accessible via mobile devices, PCs, and so on.

For example, when at least one user terminal connects to a virtual space constructed by the platform providing device 110, the platform providing device 110 may transmit to the user terminal a virtual space in which various services and functions provided by the platform providing device 110 are implemented. Consequently, users may utilize those various services and functions. In another example, when at least one user terminal connects to the virtual space constructed by the platform providing device 110, the platform providing device 110 may generate at least one avatar corresponding to the at least one user terminal, allowing the user to use the avatar to access various services and functions within the virtual space.

### Hardware Configuration

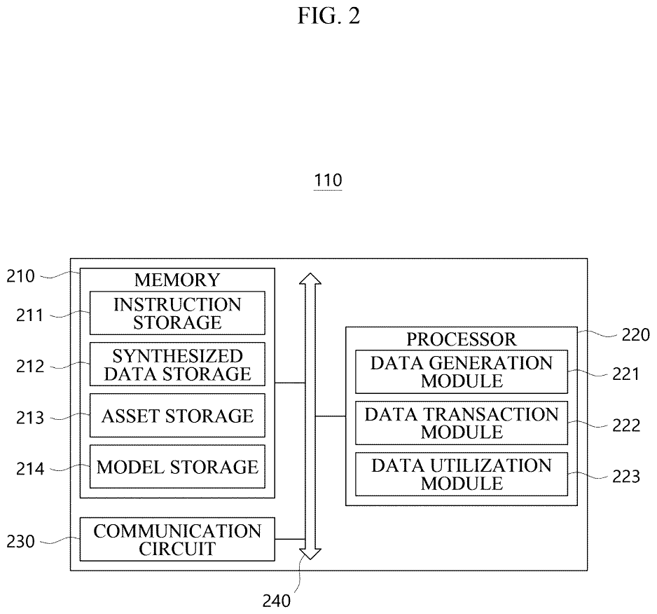

FIG. 2 is a diagram illustrating a hardware configuration of an electronic device (for example, a platform providing device or a server and/or administrator terminal included in the platform providing device) according to various embodiments.

Referring to FIG. 2, an electronic device 110 (or a computing device, e.g., a server) may include various components for providing a data platform environment. Specifically, the electronic device 110 may include a memory 210 that stores various instructions to be delivered to data and a processor, at least one processor 220 that performs operations based on instructions received from the memory 110 and controls the electronic device 110, and a communication circuit 230 that enables communication between the electronic device 110 and external devices. It should be understood that the invention is not limited to these, and additional hardware configurations and communication protocols typically included in data servers may also be provided.

Optionally, the electronic device 110 may further include an input device (not shown). The input device is the device that first receives user input from outside. For example, the electronic device 110 may further include at least one input device, such as a keyboard or mouse.

Optionally, the electronic device 110 may further include an output device (not shown). The output device is a device for displaying certain information externally from the at least one processor 220. For example, the electronic device 110 may further include at least one output device such as a display, a VR device, AR glasses, an AR projector, or a printing device.

In addition, the internal components of the electronic device 110 (e.g., a memory, at least one processor, etc.) may transfer or communicate data among each other via an internal bus 240.

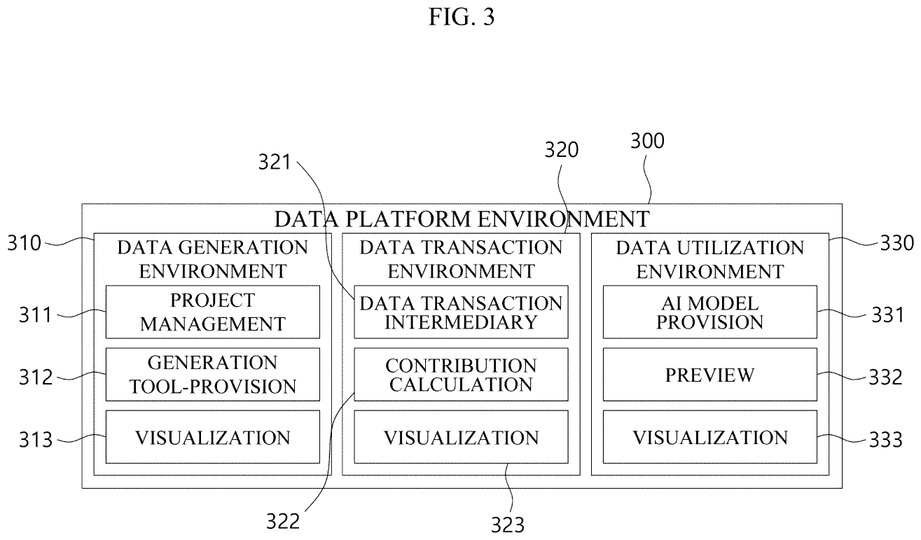

Moreover, the at least one processor 220 may include various components classified according to the functions they provide. Specifically, the at least one processor 220 may include a data generation module 221 configured to provide a data generation environment for offering a data-synthesis function to the user, a data transaction module 222 configured to provide a data transaction environment so that the user can trade data, and a data utilization module 223 configured to provide a data utilization environment for offering various data-utilization functions to the user. The present disclosure is not limited thereto, however. In particular, the data utilization module 223 may be further subdivided according to the various ways data can be utilized. Details of the diverse data environments provided by the at least one processor 220 will be described with reference to FIG. 3.

In addition, the memory 210 may include various components that are arbitrarily (or hardware-wise) divided depending on their purposes and uses. Specifically, the memory 210 may include: an instruction storage 211 configured to store instructions that direct operations by the at least one processor 220; a synthesized data storage 212 configured to store synthesized data acquired via the data generation module 221 and information associated therewith (e.g., information on the quality of the synthesized data, its domain, or reference data); an asset storage 213 configured to store block data containing data transaction information obtained via the data transaction module 222 and related information (e.g., contribution, rewards, or information about the connected blockchain network); and a model storage 214 configured to store information about, or associated with, a reference model generated via the data utilization module 223 (e.g., the reference model itself). The configuration of the memory is not limited to that disclosed in FIG. 2. The memory 210 may store various types of data that are generated by or received in the electronic device 110.

### Various Environments Implemented on the Platform

FIG. 3 is a diagram illustrating various environments provided in a data platform environment offered by an electronic device according to various embodiments.

In the present disclosure, the term “environment” refers to a concept that includes a virtual reality environment in which a user can perform a specific function, an internet environment accessible via the internet network, and so forth.

Referring to FIG. 3, an electronic device (e.g., a platform providing device) according to one embodiment of the present disclosure may construct and provide a data platform environment 300. For example, the electronic device may construct and provide a virtual environment (e.g., a metaverse platform) in which a user can enjoy various user experiences using a virtual avatar. In another example, the electronic device may construct and provide a virtual environment accessible via immersive output devices (for instance, AR glasses, VR devices, or XR devices). Further, for example, the electronic device may construct and provide an internet platform environment that a user can access via a PC or a mobile application. While the data platform environment 300 that the electronic device implements is not restricted to any one environment, it is preferably constructed as a virtual environment that encourages multiple users to actively perform a variety of functions.

According to various embodiments, the electronic device may provide a data generation environment 310. Through the data generation environment 310, the electronic device may offer various functions.

For example, the electronic device may provide a project management function 311. In the present disclosure, a “project” (or a virtual environment for data generation) can be defined as a data generation process carried out on a platform environment in which multiple participants generate a data set that meets certain requirements, or as a unit in which such a data generation process is performed. For instance, various data creators may participate in a project and use provided data generation tools to create synthesized data, and the project may continue until the data set acquired based on the created synthesized data satisfies certain requirements. The electronic device may provide the project management function 311, which includes creating a project, determining the progress of the project, or deciding whether the project should be concluded.

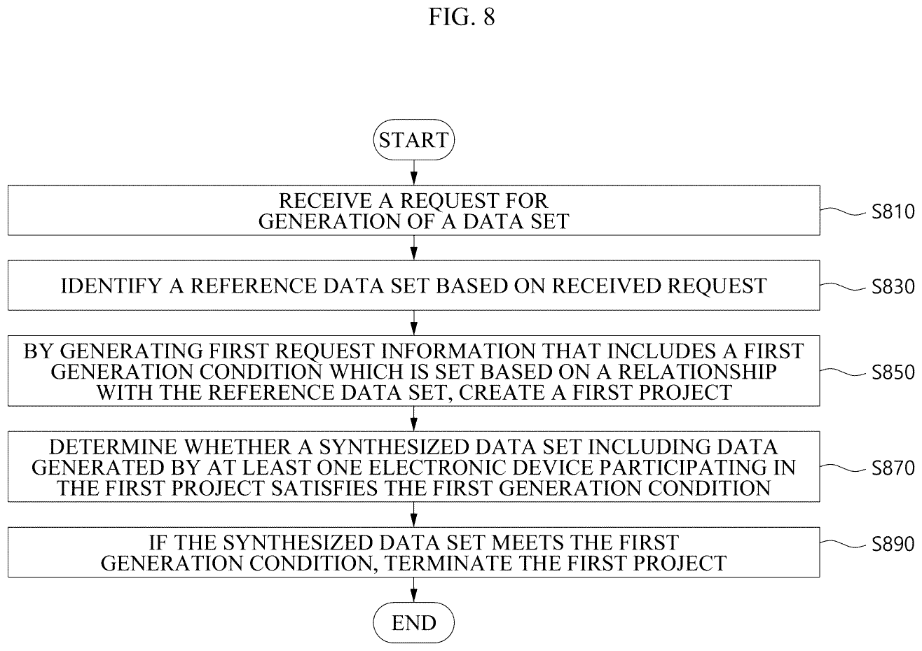

A method of generating data on a project-by-project basis, as performed by the electronic device, will be described in detail below with reference to FIGS. 8 to 17.

Additionally, for example, the electronic device may provide a generation tool-provision function 312 for data generation. Here, the term “generation tool” (or “data generation tool”) in the present disclosure may refer to a tool (e.g., a software program, etc.) used by a data creator in the platform environment to generate synthesized data. The electronic device can offer the tool-provision function 312 by providing various pre-stored generation tools to entities using the platform environment.

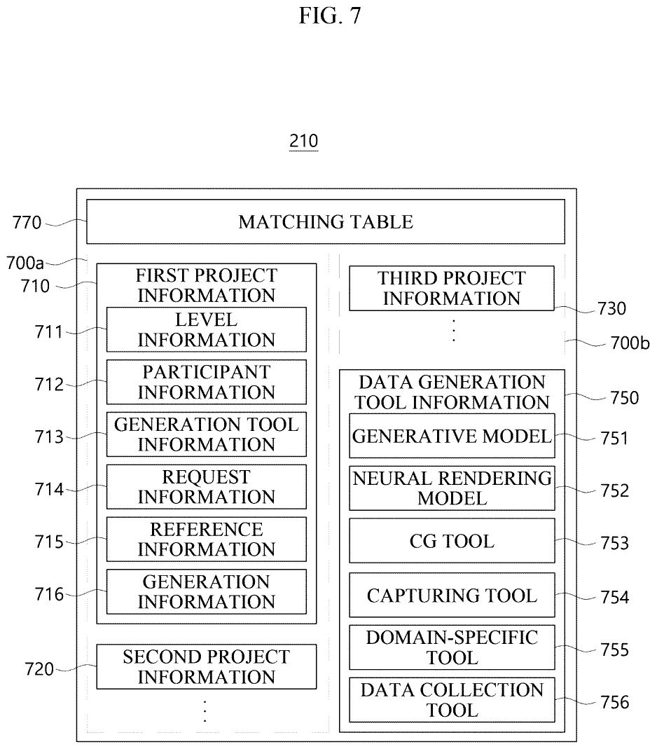

The types of data generation tools provided by the electronic device are explained in detail below (with reference to FIG. 7).

Additionally, for example, the electronic device may provide a visualization function 323 for various information handled in the data generation environment 310. Specifically, the electronic device may visually output, to a user terminal, the data generation environment 310 and information associated therewith.

Various UIs (user interfaces) that are implemented when the data generation environment 310 is visualized on a user terminal will be described in more detail below.

According to various embodiments, the electronic device may provide a data transaction environment 320. Through the data transaction environment 320, the electronic device may offer various functions.

For instance, the electronic device may provide a data transaction intermediary function 321. In this disclosure, “data transaction” is a broad concept that encompasses the exchange of data (e.g., a synthesized data set generated in the data generation environment) among entities in the platform environment, transactions involving rewards, compensation for data generation, and so forth. The electronic device may provide the data transaction intermediary function 321, enabling data transactions among entities.

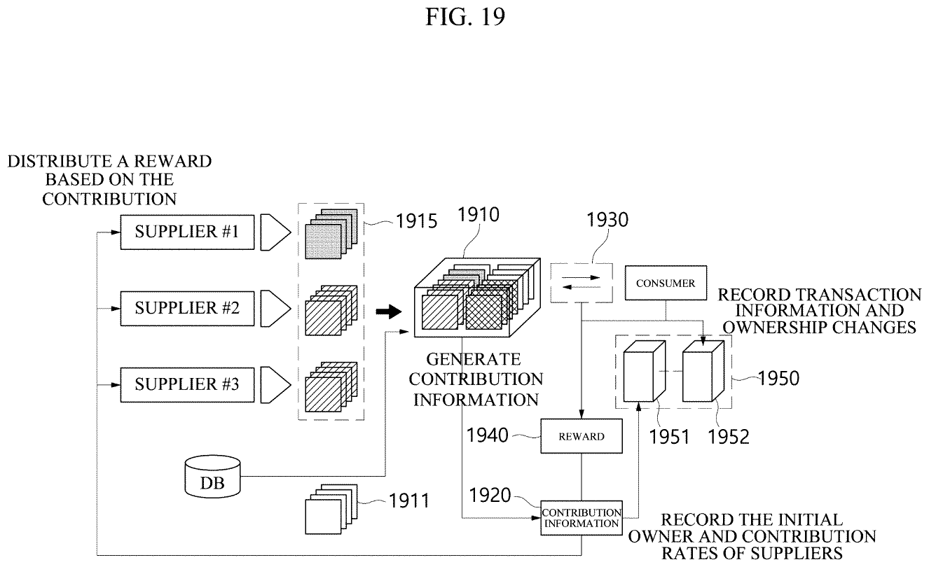

Detailed information regarding the data transaction intermediary function 321 provided by the electronic device will be described below with reference to FIGS. 19 to 28.

Additionally, for example, the electronic device may provide a contribution calculation function 322. In the present disclosure, “contribution” may refer to the extent to which each entity in the platform environment contributes to the creation of data (e.g., a synthesized data set generated in the data generation environment). The electronic device can provide the contribution calculation function 322, which evaluates and quantifies the level of contribution to the generation of a data set made by the various entities involved.

Further details on the contribution calculation function 322 provided by the electronic device will be described below.

Additionally, for example, the electronic device may provide a visualization function 323 for various information handled in the data transaction environment. Specifically, the electronic device may visually output, to a user terminal, the data transaction environment 320 and information associated therewith.

Various UIs implemented when the data transaction environment 320 is visualized on a user terminal will be described in detail below.

According to various embodiments, the electronic device may provide a data utilization environment 330. Through the data utilization environment 330, the electronic device may offer various functions.

For example, the electronic device may provide an AI model provisioning function 331. Specifically, the electronic device may offer AI model provisioning functions 331 such as: training a reference model stored in advance based on a data set (e.g., a synthesized data set generated in the data generation environment), deploying the trained AI model, verifying the AI model based on test data received externally, or providing feedback to the data creators based on the verification results.

Additionally, for example, the electronic device may provide a preview function 332. In this disclosure, “preview” may refer to displaying or showcasing an example in which a data set (e.g., a synthesized data set generated in the data generation environment) or an AI model obtained using the data set is applied to a real task in a specific domain. The electronic device may provide the preview function 332, such as visualizing and exhibiting the created data set, or demonstrating the created AI model.

Additionally, for example, the electronic device may provide a visualization function 333 for various information handled in the data utilization environment. Specifically, the electronic device may visually output, to a user terminal, the data utilization environment 330 and information associated therewith.

Various UIs implemented when the data utilization environment 330 is visualized on a user terminal will be described in more detail below.

### Device Configuration

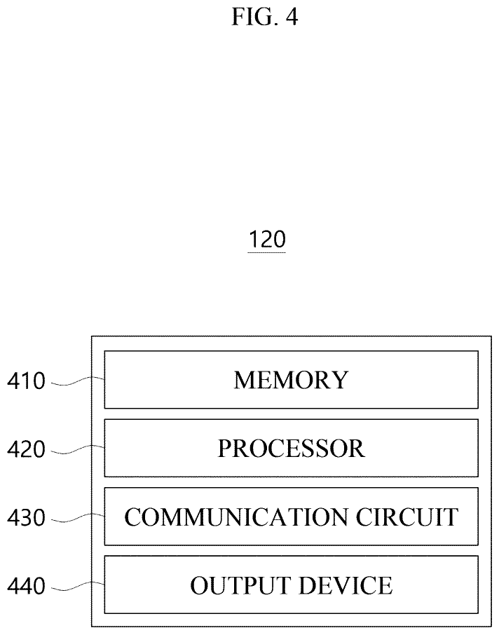

FIG. 4 is a diagram illustrating hardware configurations of an electronic device (for example, a user terminal such as a mobile phone or PC) according to various embodiments.

In one embodiment of the present disclosure, the electronic device 120 may be a user terminal for using a data platform environment provided by a server, but the disclosure is not limited thereto.

Referring to FIG. 4, the electronic device 120 according to an embodiment of the present disclosure may include a memory 410, at least one processor 420, a communication circuit 430, and an output device 440. General descriptions of the memory 410, the at least one processor 420, and the communication circuit 430 will be omitted.

The output device 440 may include not only a general-purpose display but also the aforementioned immersive output devices (for example, AR glasses, VR devices, and XR devices). In addition, the output device 440 may be implemented along with an input-device function to facilitate communication with the user. The at least one processor 420 may output a virtualized platform environment via the output device 440. For example, if a particular input is received from the user in the virtualized space implemented by the output device 440, the electronic device may provide a corresponding user interaction.

Details regarding the user interface environment output by the output device 440 will be described below.

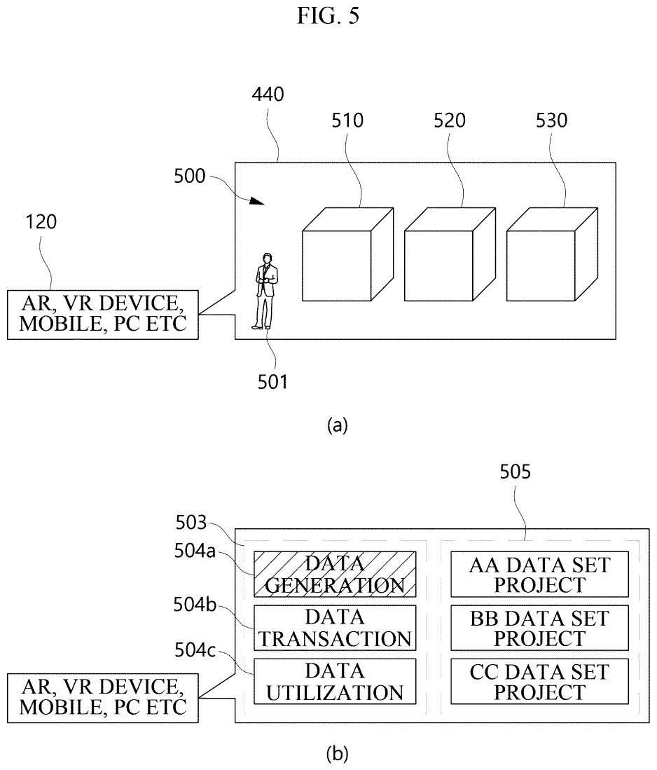

FIG. 5 is a diagram illustrating examples in which a data platform environment is implemented by an electronic device according to various embodiments.

In one embodiment of the present disclosure, the electronic device may output the data platform environment via an output device.

For instance, referring to (a) of FIG. 5, the electronic device 120 may output a virtual space 500 in which various environments of the data platform according to an embodiment are implemented. The virtual space 500 may be realized in a two-dimensional or three-dimensional environment, but is not limited thereto.

In addition, the electronic device 120 may output an avatar 501 corresponding to the user in the virtual space 500. The avatar 501 may be a computer-generated graphic icon representing the user within the virtual space 500. The characteristics of avatar 501 may be set by the user or may be set arbitrarily. For instance, the appearance or attire of avatar 501 may be selected by the user or automatically determined by the system. Furthermore, avatar 501 may move to various locations in the virtual space 500 according to the user's commands.

Furthermore, the electronic device 120 may output multiple sub-spaces (510, 520, 530) within the virtual space 500, each corresponding to a different environment implemented by the data platform. For example, the electronic device 120 may output a first sub-space 510 corresponding to a data generation environment, a second sub-space 520 corresponding to a data transaction environment, and a third sub-space 530 corresponding to a data utilization environment. In other words, a user can access the environment corresponding to one of these sub-spaces by entering it (for example, by directing the avatar to approach, or by providing an input pertaining to the sub-space).

As another example, referring to (b) of FIG. 5, the electronic device 120 may, via the output device, display on a first region 503 of the output device's screen an interface for accessing at least one of the various environments of the data platform according to the embodiment, and may display on a second region 505 of the screen an interface corresponding to the environment selected through the first region.

Further, the electronic device 120 may display a plurality of icons 504a, 504b, 504c in the first region 503, each corresponding to one of the multiple environments of the data platform. For example, the electronic device 120 may output a first icon 504a corresponding to a data generation environment, a second icon 504b corresponding to a data transaction environment, and a third icon 504c corresponding to a data utilization environment.

Moreover, the electronic device 120 may provide, via the second region 505, the environment corresponding to an icon selected by the user among the plurality of icons. For example, if the first icon 504a is selected by a user input, the electronic device 120 may output the data generation environment corresponding to the first icon 504a in the second region 505. More specifically, the electronic device 120 may display a list of data generation projects currently in progress (for instance, an AA data set generation project, a BB data set generation project, a CC data set generation project, etc.). The disclosure is not limited thereto, and the device 120 may also display a list of projects scheduled to start, completed projects, projects open for participation, projects not open for participation, etc.

### Various Actions Performed by Electronic Devices in a Data Platform Environment

In the electronic device, at least one role may be assigned depending on the operations or objectives performed in the data platform environment. Specifically, based on pre-stored role information to be assigned according to the type of data platform environment, the electronic device can allocate at least one role to each entity that uses the data platform environment. For instance, in the data generation environment, an electronic device (e.g., a server or administrator terminal) that manages a project may be assigned the role of a “producer,” who designs the project and requests data generation. In another example, in the data generation environment, an electronic device (e.g., a user terminal) that creates data may be assigned the role of a “creator,” participating in the project to generate data. Also, for instance, in the data generation environment, an electronic device (e.g., a user terminal) that requests data may be assigned the role of a “consumer,” demanding data that meets certain requirements. In addition, in the data generation environment, an electronic device that inspects newly generated data may be assigned the role of a “checker” who verifies the generated data and decides whether the project should be concluded. Similarly, in the data transaction environment, an electronic device that purchases data may be assigned the role of a “buyer,” and an electronic device that sells data may be assigned the role of a “seller.”

Furthermore, a single electronic device may be assigned multiple roles. Specifically, the electronic device may receive multiple roles in the same environment (e.g., a situation in which the device is assigned multiple roles within one project in the data generation environment, or different roles for each project) or different roles in different environments. For instance, a server that provides the data platform environment may be assigned the role of a “producer,” designing the project in the data generation environment, as well as the role of a “checker,” verifying the generated data and deciding whether the project should end. The same server may also be assigned the role of a “seller” in the data transaction environment, for example. In other words, the embodiments of the present disclosure are not limited by the name of a role assigned to an electronic device, and the name of a role may be allocated according to the device's operations in the platform environment.

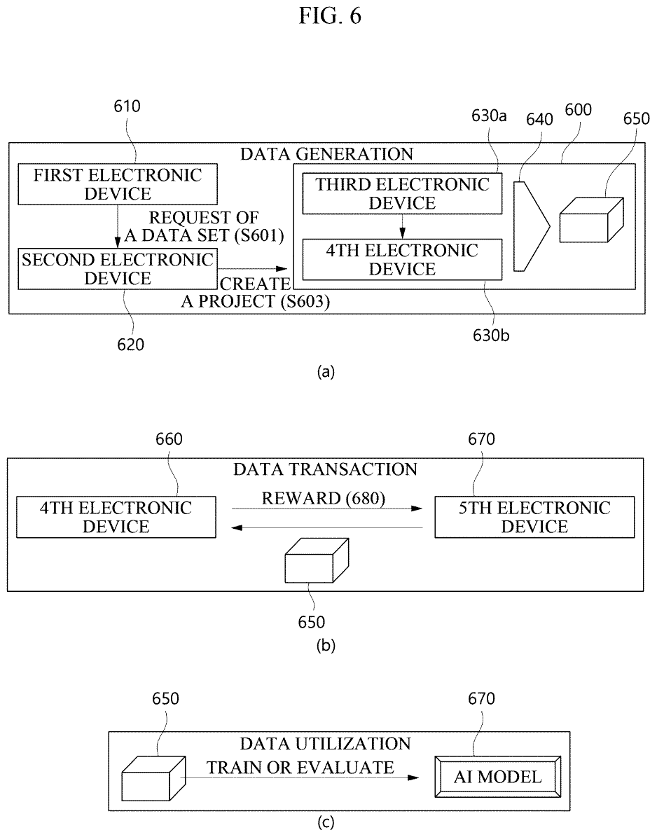

FIG. 6 is a diagram illustrating operations performed by an electronic device in a data platform environment according to various embodiments.

Referring to (a) of FIG. 6, at least one electronic device connected to the platform server may perform a data generation operation. Specifically, a first electronic device 610 (for example, a user terminal in the role of “consumer”) can request the creation of a data set from a second electronic device 620 (for example, a server in the role of “producer”) S601. In this case, based on receiving the request, the second electronic device 620 may create a project 600 for generating the data set S603.

Additionally, the second electronic device may designate at least one electronic device (for example, a third electronic device 630a and/or a fourth electronic device 630b) as entities to carry out the project 600. The third electronic device 630a and/or the fourth electronic device 630b, determined to be responsible for performing the project 600, may generate data using a data generation tool 640. Here, the data generation tool 640 is a tool for creating synthetic data and may be pre-stored on the platform server (further details on the data generation tool are provided in FIG. 7). Specifically, the server can allow the third electronic device 630a to generate synthetic data using the data generation tool 640, the fourth electronic device 630b to generate synthetic data using the data generation tool 640, and then the platform server may create a synthesized data set 650 based on at least a portion of the generated synthetic data.

Detailed information regarding the data generation operation will be described below.

Referring to (b) of FIG. 6, at least one electronic device connected to the platform server may perform a data transaction operation. Specifically, a fourth electronic device 660 (for example, a user terminal and/or a platform providing device in the role of “buyer”) and a fifth electronic device 670 (for example, a user terminal and/or a platform providing device in the role of “seller”) may execute the data transaction operation in the data transaction environment. For instance, the fourth electronic device 660 may receive the synthesized data set 650 generated by the fifth electronic device 670 by providing a predetermined reward 680 to the fifth electronic device 670.

Further details regarding the data transaction operation will be described below.

Referring to (c) of FIG. 6, at least one electronic device connected to the platform server may perform a data utilization operation. For example, at least one electronic device may train or evaluate an AI model 690 by using the synthesized data set 650, though the disclosure is not limited thereto.

More details about the data utilization operation will be described below.

### Data Generation Environment

FIG. 7 is a diagram for explaining information that an electronic device may generate or receive and store in memory, according to various embodiments.

According to various embodiments of the present disclosure, the electronic device can create a project to generate a data set (for example, a synthetic data set). Specifically, the electronic device may generate at least one piece of project information, which includes various information related to the generation of the data set, and store it in memory 210. For instance, the electronic device may store first project information 710, second project information 720, and third project information 730 in the memory 210, where the first and second refer to projects that are currently underway, and the third refers to a completed project.

In addition, the electronic device may store the project information in different regions of the memory 210 based on the current status of the project. For example, the electronic device may store ongoing project information in a first memory region 700a (e.g., a memory region designated for continuous updates), while storing completed or scheduled project information in a second memory region 700b (e.g., a memory region where updates are unnecessary or where data is deleted after a certain period).

Furthermore, the project information generated by the electronic device may include at least one piece of metadata related to the project. Specifically, the at least one piece of metadata corresponding to the project information may encompass information related to the data set intended for generation through the project, information associated with the project's progress, or project attribute information. For example, the first project information 710 can include level information 711 indicating the difficulty of generating the data set intended to be produced through the first project, participant information 712 concerning the entities participating in the first project, generation tool information 713 related to the tool used to create the data set through the first project, request information 714 associated with the data generation conditions of the first project, reference information 715 indicating reference data that is similar to the data set intended to be created through the first project, and generation information 716 indicating the current status of data set creation in the first project. However, the present disclosure is not limited to these examples.

Moreover, at least one piece of metadata corresponding to the project information may be updated. For instance, the generation information 716 included in the first project information 710 may be updated depending on the extent to which the data set has been generated. As another example, the participant information 712 included in the first project information 710 may be updated based on the number of entities determined to participate in the first project. As yet another example, the request information 714 included in the first project information 710 may be updated according to a request received from a data demander.

Additionally, for example, first metadata included in the project information may be updated based on second metadata included in the same project information. As a specific example, the level information 711 included in the first project information 710 may be updated based on the extent of data set generation, as indicated by the generation information 716. Specifically, the electronic device could be configured so that the project's difficulty decreases as the completion level of the data set created by the project becomes higher, although the present disclosure is not limited thereto.

Additionally, for instance, the generation tool information 713 included in the first project information 710 may be determined based on data generation tool information 750.

According to an embodiment of the present disclosure, the electronic device may pre-store, in the memory 210, data generation tool information 750 used to create a data set (for example, a synthetic data set). For instance, the data generation tool information 750 may include a generative model 751, a neural rendering model 752, a CG (computer graphics) tool 753 for modeling and rendering images, etc. on a computer to generate synthetic data, a capturing tool 754 that uses a specific device (for example, a general camera or an AR/VR camera) to generate synthetic data from captured images, a domain-specific tool 755 for creating synthetic data specialized to a particular domain, and a data collection tool 756 for obtaining data based on user inputs (such as data reflecting a user's preferences or priorities about certain images) using a gamification tool, among other possible tools. The present disclosure is not limited to these examples.

In this context, the generative model 751 is a model that learns input data and generates similar data conforming to the distribution of the input data. For example, the electronic device may provide either a supervised generative model (such as Linear Discriminant Analysis (LDA) or Quadratic Discriminant Analysis (QDA)) or an unsupervised generative model (for instance, a statistical generative model such as kernel density estimation, or a deep-learning-based generative model such as a GAN (Generative Adversarial Network) or a VAE (Variational Auto-Encoder)). A user terminal can generate a synthetic data set by using the generative model 751.

Moreover, the neural rendering tool 752 may operate by training a neural renderer to learn hidden information about a three-dimensional scene from multiple two-dimensional rendered images, and then use the trained neural renderer to infer two-dimensional rendered images corresponding to conditions that did not appear in the training set.

Also, the CG tool 753 may operate by modeling and rendering graphics based on at least one parameter (for instance, the amount of light, the angle of light, etc.), thereby acquiring virtual computer graphics data.

Furthermore, the capturing tool 754 may operate by generating synthetic data based on image data obtained by an electronic device that includes a camera or another capturing device. For instance, a method for generating a synthetic data set using the capturing tool 754 may involve the electronic device acquiring a synthetic data set based on at least one image captured by a user terminal and a processed image of that at least one captured image.

Additionally, the domain-specific tool 755 can be a generation tool designed and optimized for the domain of the data. For example, to create a synthetic data set in the domain of waste plastics, the electronic device may provide at least one data provider with a tool for creating plastic waste images (such as CG data of waste plastic).

Furthermore, the data collection tool 756 may operate by obtaining user preference data through user interactions. For instance, the electronic device might display two or more images on a user terminal and then acquire data related to the user's preferences based on the image(s) selected by the user among those shown.

According to an embodiment of the present disclosure, the electronic device may generate and store a matching table 770 based on relationships among various pieces of information stored in the memory 210. Specifically, the electronic device may create the matching table 770 based on the relationship between data set properties (e.g., domain, modality) and data generation tools. For example, the electronic device can generate a matching table that associates the domain of a data set (e.g., data for waste plastic images) with the optimal data generation tool (e.g., a CG tool) for generating data in that domain, and then store the table in the memory 210. In such a case, when a project for generating a particular data set is created, the electronic device may refer to the matching table 770 to identify which data generation tool corresponds to the domain of the data set to be created. The electronic device may provide the identified data generation tool to at least one electronic device (for example, a user terminal in the role of a data supplier) participating in the project.

FIG. 8 is a flowchart illustrating a method by which at least one electronic device generates a data set, according to various embodiments.

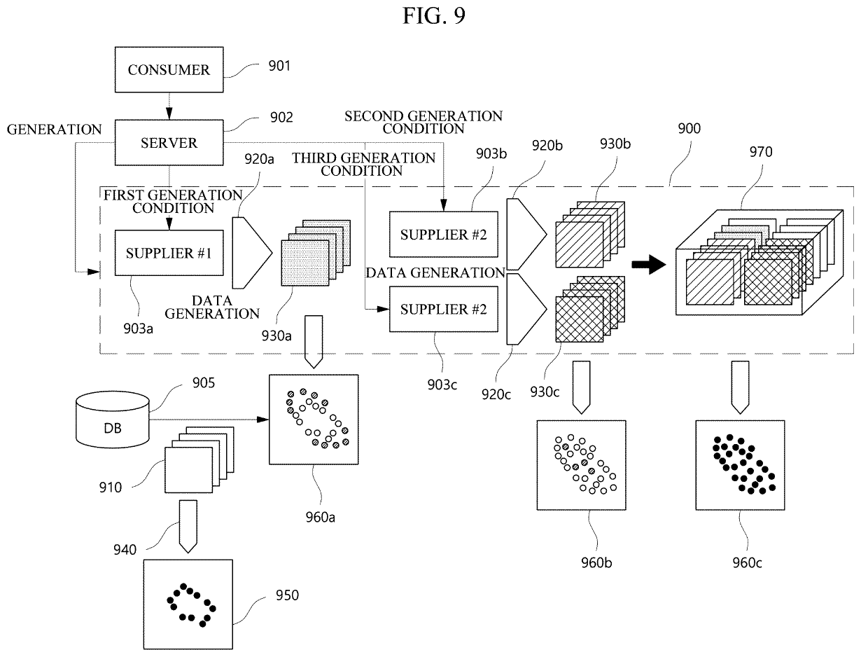

FIG. 9 is a diagram exemplarily illustrating a method by which at least one electronic device generates a data set, according to various embodiments.

In an embodiment of the present disclosure, the electronic device may enable each of at least one electronic device to generate synthetic data, and then create a data set based on the generated synthetic data. Specifically, the electronic device may create a project for generating a data set and have the at least one electronic device participate in this project; once data set generation is completed by the at least one electronic device, the electronic device can end the project, thereby producing the data set.

As one example, referring to FIG. 8, a first electronic device may receive a request for generation of a data set S810. In this context, the first electronic device may receive the request from a second electronic device (e.g., a user terminal acting as a “consumer”). For instance, referring to FIG. 9, the consumer terminal 901 may transmit a request for generation of a data set to a server 902. Specifically, the request for generation of the data set may include requirements for the data set to be generated. For example, the request for data set generation may include properties of the required data set—such as domain, volume, or modality—along with the required quality of the data set or sample data for the required data set, but is not limited thereto.

In addition, the first electronic device may identify a reference data set based on receiving the request for data set generation S830. In this context, the first electronic device may identify properties of the required data set based on the request for data set generation, and then search through multiple reference data sets pre-stored in memory to find at least one reference data set corresponding to the identified properties. For example, referring to FIG. 9, the server 902 can check among the reference data sets pre-stored in a built database 905 (or memory) to identify a first reference data set 910 corresponding to the request received from the consumer terminal 901.

Additionally, by generating first request information that includes a first generation condition which is set based on a relationship with the reference data set, the first electronic device may create a first project S850. Specifically, the first electronic device may obtain first request information including the first generation condition set based on the relationship with the reference data set, and then provide a first virtual environment for data generation based on the first request information. In this context, “providing the first virtual environment (or the first project)” may refer to allowing multiple platform users to access the first virtual environment on the platform. The first electronic device can store in memory a first project information comprising not only the first request information but also all other information associated with the first project. Specifically, the first request information can include the first generation condition, the identified reference data set, or sample data included in the received request, among other possibilities. For instance, referring to FIG. 9, by generating first request information containing a first generation condition set according to the relationship with the first reference data set 910, the server 902 can create a first project 900 (or first virtual environment). Additionally, the server 920 may deliver the first generation condition to a first supplier terminal 903a participating in the first project 900.

At this point, the first electronic device may determine, according to predefined criteria, at least one electronic device that will participate in the first project for data generation and produce data. Specifically, if the first electronic device receives an indication of willingness to participate in the project (or a request to access the first virtual environment) from at least one electronic device, it can judge whether that device is suitable for carrying out the project. For example, based on the level information of the first project, the first electronic device may decide whether to allow the at least one electronic device to participate in the project by determining whether the data generation level of that device meets the level information. Moreover, not limited thereto, the first electronic device may select at least one electronic device suitable for generating data by participating in the project, based on the first project information, and then transmit a suggestion to participate in the project to the selected device(s). If the project's level information is extremely low (for example, data generation by choosing preferred images), the system could be configured so that any electronic device can participate in the project, regardless of its data-generation level.

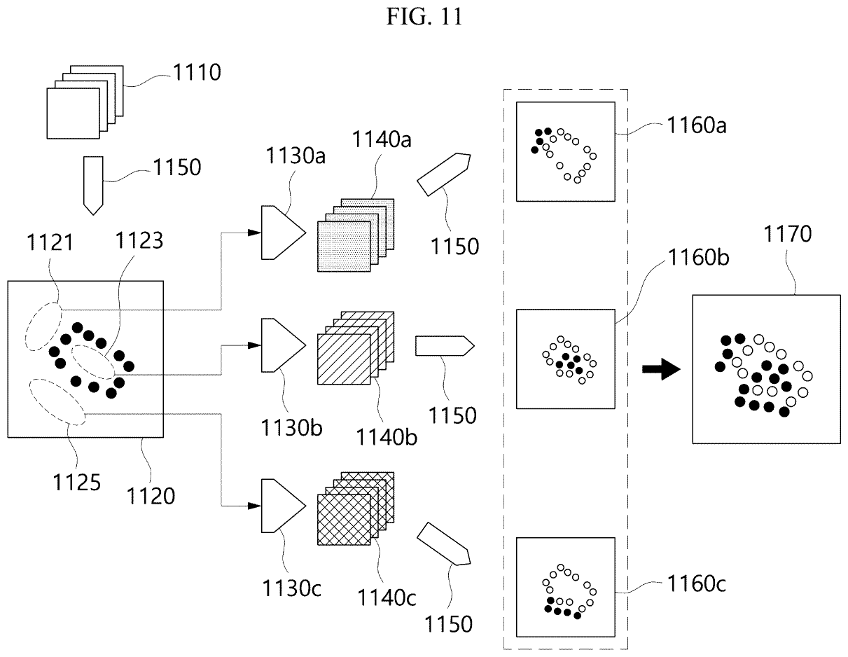

Additionally, the first request information may include at least one more generation condition in addition to the first generation condition. Specifically, based on the request received from the consumer terminal 901 and the identified first reference data set 910, the electronic device may generate a plurality of different generation conditions and then transmit these conditions to multiple supplier terminals. For instance, the server 902 can transmit the first generation condition to the first supplier terminal 903a and a second generation condition (which differs from the first one) to the second supplier terminal 903b. In this scenario, the first generation condition and the second generation condition transmitted to at least one supplier terminal may differ in terms of how they relate to the first reference data set 910. Concretely, the server 902 may create a first generation condition requesting that the device produce data with a first correlation to the first reference data set 910 and transmit it to the first supplier terminal 903a, while creating a second generation condition requesting the device produce data with a second correlation—different from the first correlation—to the first reference data set 910 and transmit it to the second supplier terminal 903b. In this case, the relationship with the first reference data set 910 can be represented based on the data image (Image of Data). The method for providing generation conditions based on a data image is described in detail with reference to FIG. 11.

Moreover, and not limited thereto, the first electronic device can transmit the same generation condition to different electronic devices. For example, the server 902 may transmit a second generation condition to the second supplier terminal 903b and transmit a third generation condition—identical to the second—to the third supplier terminal 903c.

Additionally, the first electronic device can provide at least one data generation tool to the data supplier. Specifically, based on predefined criteria, the first electronic device may select at least one data generation tool from among multiple tools stored in the memory and transmit it to the data supplier. For example, based on the matching table, the first electronic device may select and transmit at least one generation tool suited to creating the required data. In another example, the first electronic device can provide at least one data generation tool used to create the identified reference data set, based on the identified reference data set. As yet another example, the first electronic device can provide at least one data generation tool identified by a request (received from a data demander) based on that request. Further, for instance, the first electronic device may select at least one data generation tool suitable for the data generation condition and transmit it. Consequently, at least one electronic device participating in the project for data generation (for example, a user terminal in the role of a data supplier) may generate data using the provided data generation tool(s).

Referring again to FIG. 9, the server 902 may provide a first data generation tool 920a to a first supplier terminal 903a, and the first supplier terminal 903a may generate a first data set 930a using the first data generation tool 920a.

Moreover, the server 902 may provide different data generation tools to multiple supplier terminals. For example, the server 902 may provide a first data generation tool 920a to the first supplier terminal 903a, a second data generation tool 920b to the second supplier terminal 903b, and a third data generation tool 920c to the third supplier terminal 903c. The data generation tools provided to each supplier terminal may be selected in consideration of that terminal's data generation level, specialization, or required contribution, among other factors. Details about this are described with reference to FIG. 11.

The first electronic device may provide a data imaging tool for providing a data image (Image of Data) corresponding to the created data. In this context, the data image can be an image that visualizes data based on its distribution. Specifically, the data image may be a visual representation reflecting intrinsic relationships of the data (for example, distances between data points, the data's distribution, or bias in the data), and each data point can be displayed as an individual point on the data image. In other words, by furnishing the data image of the data generated by the data imaging tool, the first electronic device can encourage the data supplier to check the properties(or attributes) of the data currently being created (for instance, its distribution, density, relationships to other data, and so on).

Referring again to FIG. 9, the server 902 may provide a data imaging tool 940, and based on that data imaging tool 940, the server can provide a reference image 950 corresponding to the reference data set 910. Further, the first supplier terminal 901a can use the data imaging tool 940 to check a first data image 960a, which corresponds to the generated first data set 930a. At this time, the first data image 960a may be provided in such a way as to visually highlight the data generated by the first supplier terminal 901a, though not necessarily limited to that approach. In addition, the second supplier terminal 902b and/or the third supplier terminal 902c can use the data imaging tool 940 to identify a second data image 960b corresponding to the generated second data set 930b and/or third data set 930c. Moreover, the server may provide a third data image 960c corresponding to the synthesized data set 970, which includes the reference data set and the data sets generated by all the data suppliers.

Additionally, the first electronic device may provide a visual indicator corresponding to the data generation condition on the data image displayed by the data generation tool. Further details are described with reference to FIG. 11.

Referring again to FIG. 8, the first electronic device may determine whether a synthesized data set including data generated by at least one electronic device participating in the first project satisfies the first generation condition S870. Specifically, the first electronic device may check whether the synthesized data set created by at least one user terminal accessing the first virtual environment satisfies the first generation condition. Furthermore, if the synthesized data set meets the first generation condition, the first electronic device may terminate the first project S890. Concretely, based on a determination result that the synthesized data set satisfies the first generation condition, the first electronic device may block user access to the first virtual environment. In other words, in deciding whether to close a project for data generation, the first electronic device may determine whether the data generated by at least one electronic device conforms to the generation condition associated with the project.

Additionally, if multiple generation conditions are assigned to a plurality of electronic devices participating in the project, the first electronic device may decide whether to end the project based on those multiple generation conditions. For example, the first electronic device may determine to end the project when at least some minimum number of the multiple generation conditions are satisfied, but it is not limited to this approach.

Referring again to FIG. 9, by determining whether the synthesized data set 970—which includes data generated by multiple supplier terminals—meets the data generation conditions, the server 902 can decide whether to terminate the first project 900 for data generation. Specifically, the server 902 may check whether the synthesized data set 970 satisfies at least a predetermined threshold of multiple generation conditions: for instance, a first generation condition requiring that data exhibit a first correlation to the reference data set 910, a second generation condition requiring data exhibit a second correlation to the reference data set 910, and a third generation condition requiring data exhibit a third correlation to the reference data set 910. For example, if the synthesized data set 970 satisfies all the multiple generation conditions, the server 902 may terminate the data generation project. In another example, the server 902 could end the project if the synthesized data set 970 satisfies at least a certain percentage of those multiple generation conditions. As a concrete example, based on a third data image 960c corresponding to the synthesized data set 970, the server 902 may verify the percentage of data created in certain regions that require data generation, then decide whether the multiple generation conditions are satisfied above the predetermined threshold.

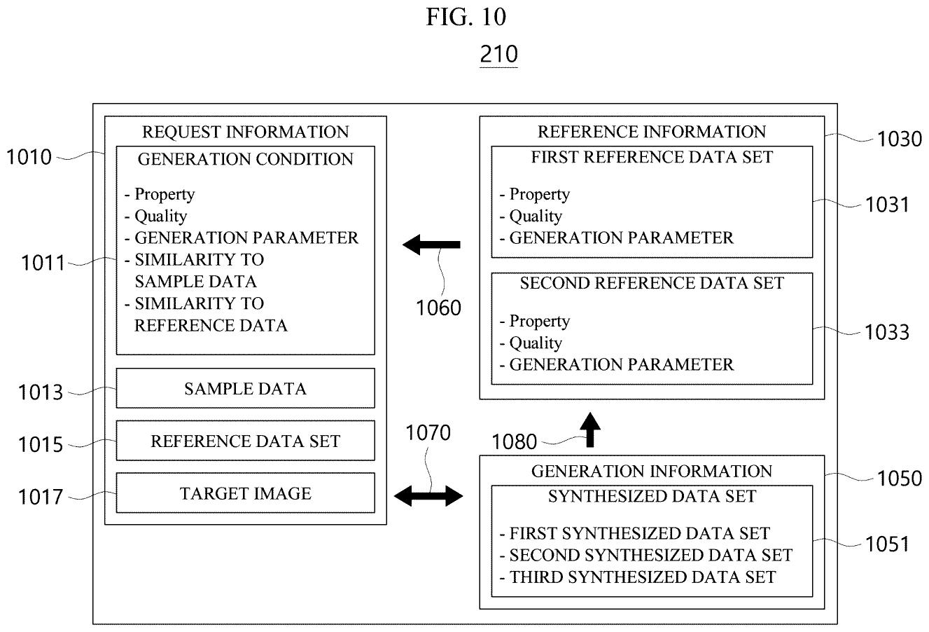

FIG. 10 is a diagram illustrating an operation in which an electronic device updates the information of a project for data generation, according to various embodiments.

Referring to FIG. 10, when a request for data generation is received, the electronic device may generate request information 1010 based on the request and store it in memory 210. In this context, the request information 1010 may include at least some of the following: a generation condition 1011 associated with data generation requirements, sample data 1013 received from a data demander, a reference data set 1015, or a target image 1017 obtained by virtually generating an imaging result for the data set to be created.

In addition, the electronic device may store reference information 1030, which includes various reference data sets related to the synthesized data set (for instance, a database constructed based on synthetic data sets created within the platform), in the memory 210.

Furthermore, the electronic device may generate generation information 1050, which includes information about the generated synthetic data, and store it in memory 210.

According to various embodiments, the electronic device may perform an incorporation operation 1060 that creates request information 1010 based on reference information 1030. Specifically, in accordance with the incorporation operation 1060, the electronic device can generate the request information 1010 from the reference information 1030. For example, the electronic device may include a first reference data set 1031 included in the reference information 1030 when acquiring the request information 1010. In this case, the request information 1010 may include not only the first reference data set 1015, but also a generation condition defined based on its similarity to the first reference data set 1031, or a target image that reflects the first reference data set 1031. The incorporation operation 1060 may be carried out at the stage of creating a project for data generation.

Moreover, the electronic device may perform a comparison operation 1070 that compares the request information 1010 and the generation information 1050 to check whether the required data corresponds to the data being generated. Specifically, in order to verify that the data being created aligns with the required conditions, the electronic device can compare the synthesized data set 1051 included in the generation information 1050 with the generation condition 1011 included in the request information 1010. For instance, the electronic device might evaluate the quality of the synthesized data set 1051, thus determining whether the required quality specified by the generation condition 1011 has been achieved. Alternatively (and not limited thereto), the electronic device may check multiple elements contained in the generation condition 1011 (e.g., properties, generation parameters, similarity to sample data, similarity to reference data) to carry out the comparison operation 1070. This comparison operation 1070 may be performed during the course of the project for data generation.

To evaluate the quality of the synthesized data set described above, the electronic device may store and utilize a quality evaluation model. Specifically, the electronic device can calculate the distance among data points in the synthesized data set and then evaluate the quality of the synthesized data set based on that distance. For instance, the electronic device may compute an assessment index that indicates the quality of the synthesized data set, based on at least one of its density, bias, or uniformity among data points, as determined by the distances between data points.

Additionally, based on the generation information 1050, the electronic device may carry out an update operation 1080 that updates the reference information 1030. Specifically, the electronic device can update the reference information 1030 by storing the generated synthesized data set in the database as a reference data set. For instance, the electronic device may obtain a second reference data set 1033 based on the synthesized data set produced from the first, second, and third synthesized data sets, and then update the reference information 1030 to include the second reference data set 1033. This update operation 1080 may be performed once the project for data generation is concluded.

FIG. 11 is a diagram illustrating a method by which an electronic device provides a data image to perform a data generation operation, according to various embodiments.

Referring to FIG. 11, the electronic device may use a data imaging tool 1150 to acquire a reference image 1120 based on a reference data set 1110. In this context, the reference image 1120 may be data that visualizes, as data points, the data included in the reference data set 1110.

Additionally, the electronic device may generate the reference image 1120 to include a visual indicator corresponding to at least one generation condition associated with the required data. Specifically, the electronic device can create, within the reference image 1120, a first visual indicator 1121 corresponding to a first generation condition (e.g., data having a first correlation with the reference data set), a second generation condition (e.g., data having a second correlation with the reference data set), and a third generation condition (e.g., data having a third correlation with the reference data set). In such a case, the electronic device may place these visual indicators in the areas of the imaging space where data is required. For example, the electronic device can generate the first visual indicator 1121 to represent a first region in the imaging space, generate the second visual indicator 1123 to represent a second region in the imaging space, and generate the third visual indicator 1125 to represent a third region in the imaging space. By visually providing guidance for data generation in this manner, a data supplier terminal may be asked to produce data that fits the region corresponding to the visual indicator.

Additionally, the electronic device can provide at least one data generation tool corresponding to at least one generation condition to at least one supplier terminal. Specifically, based on the at least one generation condition, the electronic device may select and provide the data generation tool best suited to creating data that meets that condition. For example, in order to request data generation in accordance with the first generation condition, the electronic device may provide a first generation tool 1130a to a first data supplier. For the second generation condition, it may provide a second generation tool 1130b to a second data supplier, and for the third generation condition, it may provide a third generation tool 1130c to a third data supplier. Accordingly, the first data supplier may create a first synthesized data set 1140a using the first generation tool 1130a, the second data supplier may create a second synthesized data set 1140b using the second generation tool 1130b, and the third data supplier may create a third synthesized data set 1140c using the third generation tool 1130c.

In addition, the electronic device may provide additional information related to data generation together with the data generation tool. For example, the electronic device can provide a CG tool along with a range of CG parameters that conform to the generation condition, but this approach is not limited thereto.

Furthermore, the electronic device can obtain a data image corresponding to the generated synthesized data set by using the data imaging tool 1150. For instance, the electronic device may acquire a first data image 1160a based on the first synthesized data set 1140a, a second data image 1160b based on the second synthesized data set 1140b, and a third data image 1160c based on the third synthesized data set 1140c, using the data imaging tool 1150. In such a case, the electronic device can visually distinguish the data included in the synthesized data set generated by a data supplier from existing data.

Moreover, based on the multiple synthesized data sets 1140a, 1140b, 1140c or the multiple data images 1160a, 1160b, 1160c, the electronic device can obtain a consolidated data image 1170 corresponding to the synthesized data set.

In this scenario, the electronic device can check whether the multiple data points contained in the consolidated data image 1170 are generated in the region required by at least one generation condition. For instance, the electronic device may determine whether multiple data points corresponding to the first synthesized data set 1140a within the consolidated data image 1170 have been generated in a first region of the imaging space corresponding to the first generation condition. Thus, the electronic device can verify whether the synthesized data sets created by the data suppliers have been generated in conformity with the generation condition.

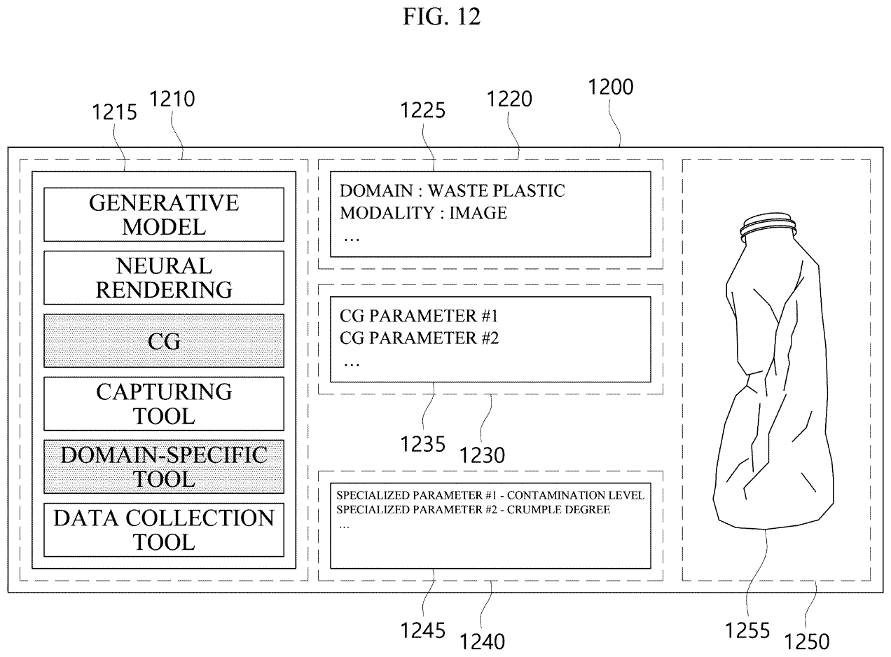

FIG. 12 is a diagram illustrating a user interface through which an electronic device generates data using a data generation tool, according to various embodiments.

Referring to FIG. 12, an electronic device (for example, a user terminal) can utilize an output device 1200 to form a user interface for data generation and display various information. The output device 1200 may be included in the electronic device or connected to it via electrical and/or communication means. As noted above, it can include not only a conventional display screen but also any form of virtual display screen, such as in virtual reality and/or augmented reality.

Specifically, the output device 1200 may include a first region 1210 in which data generation tools used for creating data can be selected. The electronic device may display tool information 1215, containing data generation tools, in the first region 1210 of the output device. At that point, at least some of the various data generation tools may be chosen by the user, and the electronic device can be configured to provide the chosen tool(s).

Additionally, the output device 1200 may include a second region 1220 that allows verification of general properties of the data to be generated. The electronic device can display property information 1225 about the data, such as the domain and modality of the data, in the second region 1220 of the output device. The property information 1225 may be obtained based on the request information for data generation. Moreover, the user can verify the properties of the data to be generated via the property information 1225.

Moreover, the output device 1200 may include at least one space for providing generation-assistance information that corresponds to each of the selected generation tools. For instance, the output device 1200 could include a third region 1230 for providing first generation-assistance information 1235 corresponding to a first generation tool (e.g., a CG tool). Additionally, the output device 1200 could include a fourth region 1240 for providing second generation-assistance information 1245 corresponding to a second generation tool (e.g., a domain-specific tool).

In this configuration, the generation-assistance information may be obtained based on at least one generation parameter corresponding to the generation tool. Specifically, the electronic device can generate and display generation-assistance information based on at least one generation parameter corresponding to the generation tool chosen by the user. Additionally, some of these generation parameters may be adjusted based on user inputs in the third region 1230 and/or the fourth region 1240, allowing the user to confirm the current generation parameters of the data being created via the third region 1230 and/or the fourth region 1240.

Additionally, the generation-assistance information displayed through the output device may be determined based on the selected generation tool. Specifically, the electronic device can identify the selected generation tool, check at least one generation parameter matching that tool, and then produce and provide generation-assistance information to allow for the adjustment or verification of that parameter. For instance, based on user input for a domain-specific tool, the electronic device may identify at least one generation parameter specialized for “waste plastic” data (for example, parameters including contamination level, crumple degree, transparency, shape, material, presence or absence of a cap, color, size, labeling presence, and so forth, which go beyond simple RGB to consider various optical properties related to the waste plastic domain). The electronic device can then produce generation-assistance information based on these parameters and show it in the fourth region 1240.

Moreover, the output device 1200 may include a fifth region 1250 for representing the synthesized data created (or being created) using the chosen generation tool. Specifically, based on the synthesized data created by the selected generation tool, the electronic device can display visual information 1255 about the synthesized data and/or a data image (not shown) corresponding to the synthesized data through the fifth region 1250.

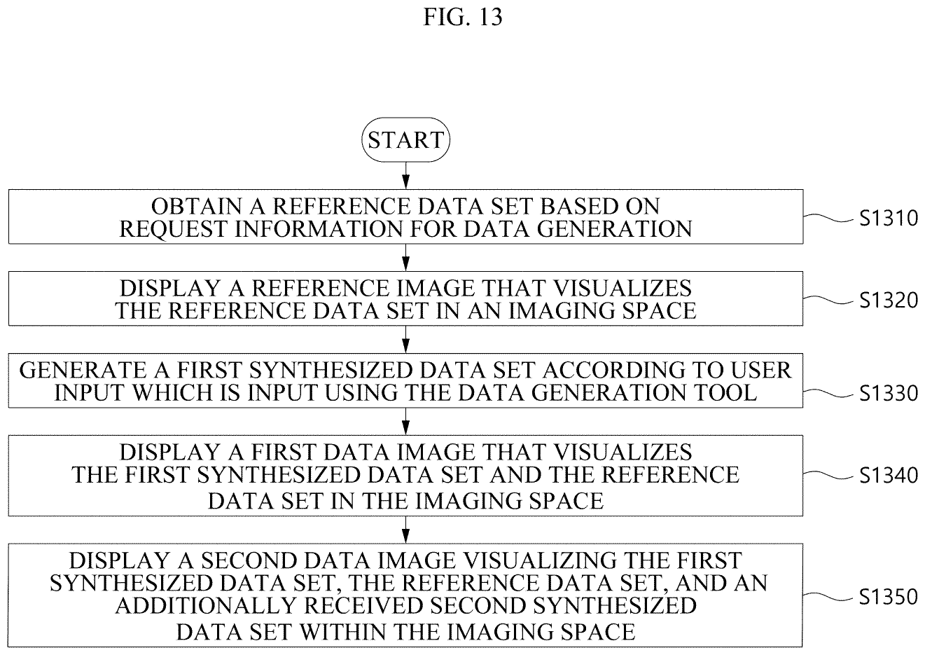

FIG. 13 is a flowchart illustrating a method by which the electronic device provides generated data in a visualized form, according to various embodiments.

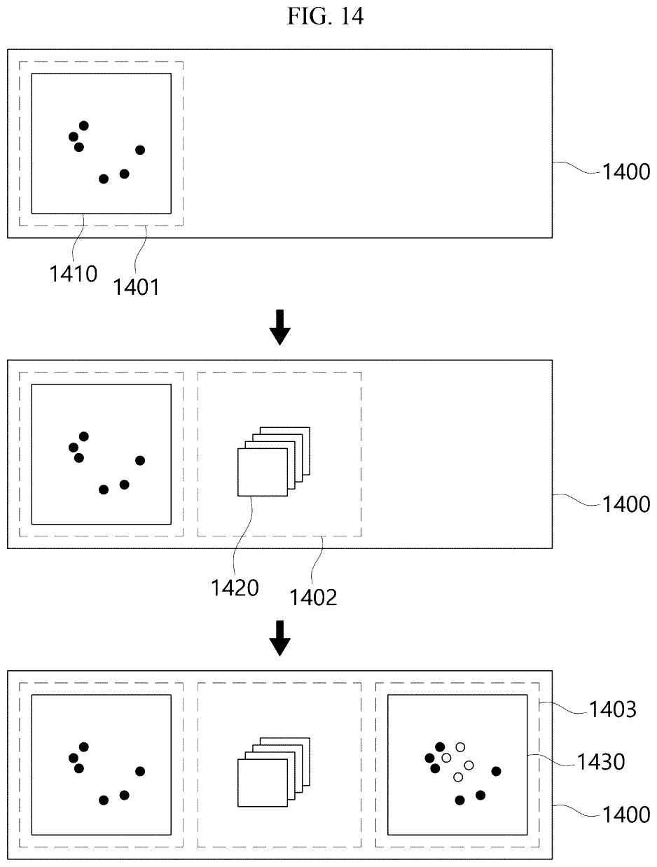

FIG. 14 is a diagram illustrating a user interface in which the electronic device provides generated data in a visualized form, according to various embodiments.

Referring to FIG. 13, the electronic device can obtain a reference data set based on request information for data generation S1310. Then, the electronic device can display a reference image that visualizes the reference data set in an imaging space via an output device S1320. For instance, referring to FIG. 14, the electronic device may acquire a reference image 1410 based on a reference data set corresponding to the request information, and display the reference image 1410 in a first region 1401 of the output device's screen.

Additionally, the electronic device can generate a first synthesized data set according to user input which is input using the data generation tool S1330. While the data generation tool may be selected by user input as described with reference to FIG. 12, the electronic device may alternatively choose a tool in a predefined manner depending on the properties of the data requested for generation, and then provide it to the user terminal. For example, referring to FIG. 14, the electronic device can display a first synthesized data set 1420 created by the data generation tool in a second region 1402 of the output device. The second region 1402 may be implemented in the user interface depicted in FIG. 12, although it is not limited thereto.

Additionally, the electronic device can display a first data image that visualizes the first synthesized data set and the reference data set in the imaging space S1340. Specifically, the electronic device may acquire the first data image by visually differentiating the reference data set from the first synthesized data set (e.g., by using a distinct color, etc.). For example, referring to FIG. 14, the electronic device may obtain a first data image 1430 by representing the reference data set 1410 and the first synthesized data set 1420 in a virtual imaging space, and then display the first data image 1430 in a third region 1403 of the output device.

Additionally or optionally, the electronic device may display a second data image visualizing the first synthesized data set, the reference data set, and an additionally received second synthesized data set within the imaging space. In that case, the second synthesized data set might be data further generated by the same terminal that provided the first synthesized data set, or it might be generated by another terminal.

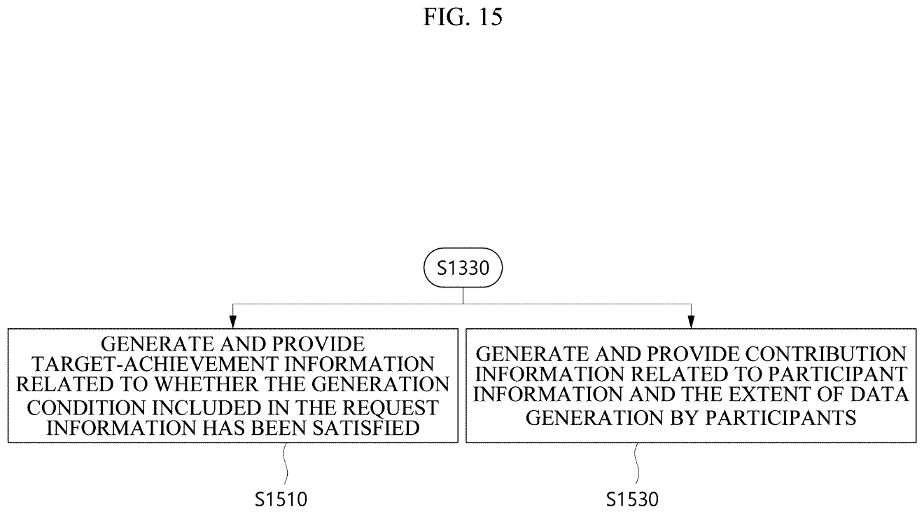

FIG. 15 is a flowchart for explaining additional information that an electronic device can provide related to data generation, according to various embodiments.

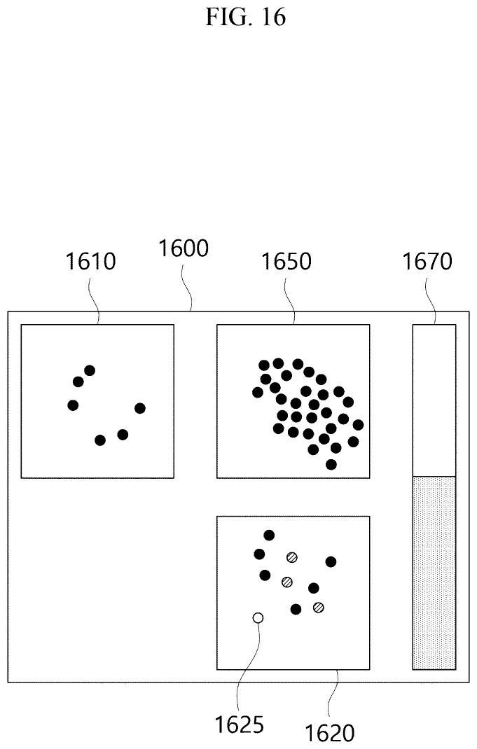

FIG. 16 is a diagram illustrating one embodiment of a user interface in which the electronic device provides additional information related to data generation, according to various embodiments.

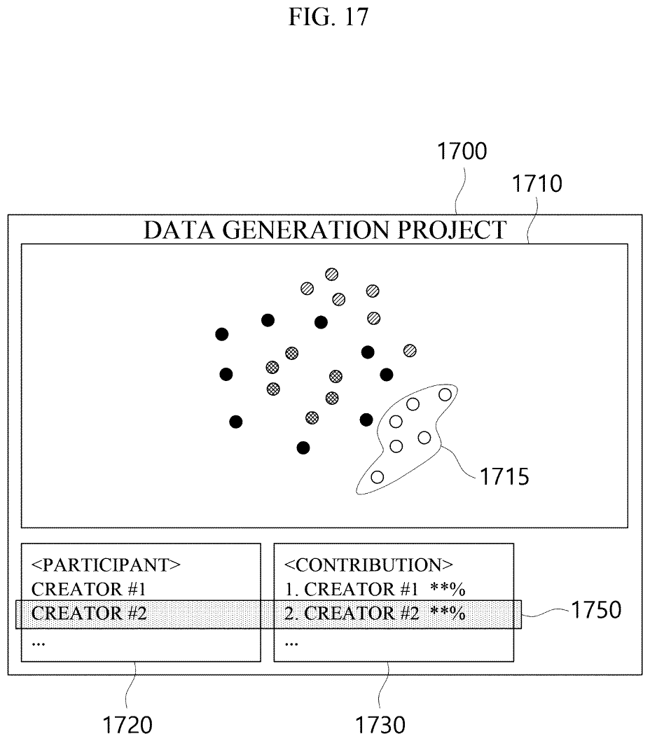

FIG. 17 is a diagram illustrating another embodiment of a user interface in which the electronic device provides additional information related to data generation, according to various embodiments.

Referring to FIG. 15, after generating the first synthesized data set according to step S1330 of FIG. 13, the electronic device may generate and provide target-achievement information related to whether the generation condition included in the request information has been satisfied S1510. Specifically, the target-achievement information may include how much of the generation condition indicated by the request information has been met, or how closely it matches the required data, among other possibilities. For instance, the electronic device can visually represent the extent to which the synthesized data set created by the data supplier meets the required generation condition.

As one example, referring to FIG. 16, the electronic device may use an output device 1600 to display a reference image 1610 corresponding to a reference data set, and a first data image 1620 corresponding to both the reference data set and the first synthesized data set. In this scenario, the electronic device can create and provide a visual target image 1650 for the synthesized data set that needs to be generated. The target image 1650 may be a data image corresponding to the synthesized data set to be created. By inferring which data points are needed according to the request information, the electronic device can generate and provide the target image 1650. In addition, the electronic device can generate target-achievement information 1670 that indicates how well the first synthesized data set conforms to the data generation condition, and display it via the output device 1600. In this instance, the electronic device might visualize the achievement ratio in a bar form to create the target-achievement information 1670, though it is not limited to that form. Moreover, if the generated first synthesized data set includes outlier data 1625 that does not meet the generation condition, the electronic device may also provide a visual indicator prompting the user to examine that outlier data 1625. Additionally or alternatively, the electronic device can request improvements to the outlier data 1625 from the user terminal or provide updated data.

Also optionally, additionally, or alternatively, following the generation of the first synthesized data set in step S1330 of FIG. 13, the electronic device may generate and provide contribution information related to participant information and the extent of data generation by participants S1530. Specifically, participant information can refer to information about the data suppliers participating in the data generation project, and contribution information can refer to information indicating each supplier's contribution to the data generation, assessed based on the data generated by each data supplier.

As one example, referring to FIG. 17, the electronic device may display, using an output device 1700, a data image(Image of Data) 1710 for the synthesized data currently being generated in a data generation project. In doing so, the electronic device can display a data image 1710 that includes a visual effect 1715 highlighting the data created by the user terminal connected to the output device 1700. Additionally, the electronic device can display participant information 1720, which indicates information about the data suppliers participating in the data generation project, via the output device 1700. The electronic device can also display contribution information 1730, which reflects how much each data supplier has contributed to the data generation, through the output device 1700. In this situation, the electronic device can provide a visual effect 1750 for displaying the participant and that participant's contribution, corresponding to the user terminal connected to the output device 1700.

### Data Transaction Environment

According to various embodiments of the present disclosure, an electronic device can provide a data transaction environment for data sets (for example, synthetic data sets) among multiple entities. In a data transaction conducted via the platform, it is necessary to store information associated with the transaction in a decentralized manner to ensure a secure trading environment, and to establish a standard for fairly distributing the rewards associated with the transaction among the data providers who generated the data.

To offer a secure environment with clear reward distribution, an electronic device according to various embodiments of this disclosure provides a data transaction method based on a blockchain network, as well as a method for assessing contribution in data generation so that rewards can be clearly apportioned.

Below, these methods—the data transaction method based on the aforementioned blockchain network and the method for evaluating contribution to data generation for unambiguous reward distribution—will be explained in detail.

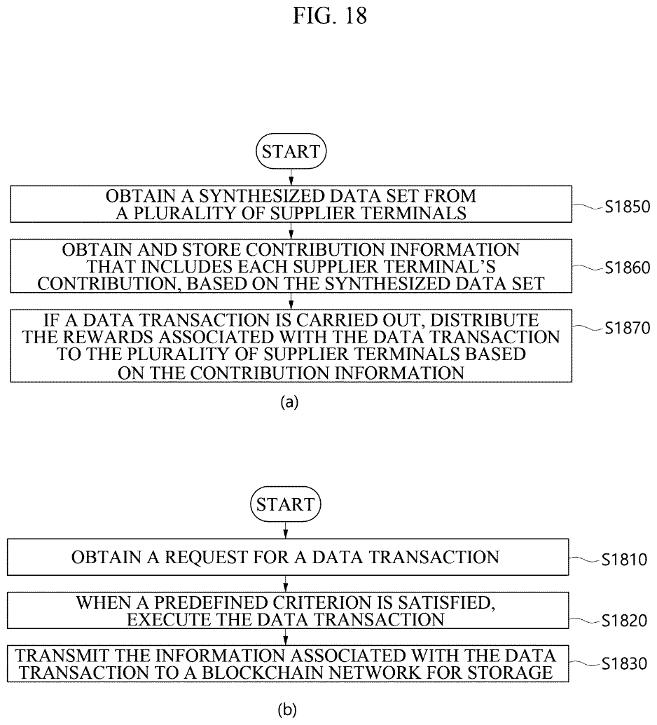

FIG. 18 is a diagram describing functions by which an electronic device can provide a data transaction environment, according to various embodiments.

FIG. 19 is a schematic diagram illustrating a method by which an electronic device provides a data transaction environment, according to various embodiments.

Referring to (a) of FIG. 18, the electronic device may obtain a synthesized data set from a plurality of supplier terminals S1850. The specific method of generating a synthesized data set from multiple supplier terminals is described above, so further explanation is omitted.

For example, referring to FIG. 19, multiple supplier terminals (e.g., supplier #1, supplier #2, and supplier #3) can generate multiple sub-data sets 1915 using data generation tools. In addition, the electronic device can obtain a synthesized data set 1910 based on the plurality of sub-data sets 1915 and a reference data set 1911 provided for data generation.

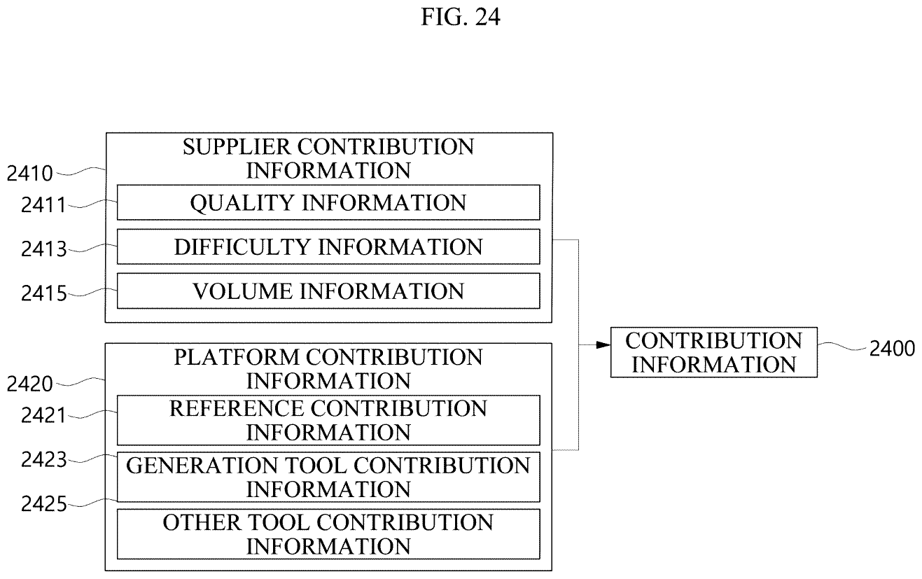

Referring again to (a) of FIG. 18, the electronic device can obtain and store contribution information that includes each supplier terminal's contribution, based on the synthesized data set S1860. In this context, the contribution information may include the contribution (supplier contribution information) of each of the multiple supplier terminals, as well as other information. Further details are provided in FIG. 24.

For example, referring to FIG. 19, the electronic device can generate contribution information 1920 that reflects the level of data contribution by the plurality of supplier terminals by evaluating the synthesized data set 1910 according to a predefined criterion.

Further, referring again to (a) of FIG. 18, if a data transaction is carried out, the electronic device may distribute the rewards associated with the data transaction to the plurality of supplier terminals based on the contribution information S1870. In this case, the data transaction can be performed as shown in (a) of FIG. 18, but is not limited to that manner.

For example, referring to FIG. 19, the electronic device can distribute a reward 1940—obtained on the basis of a data transaction 1930 with a consumer—to each of the plurality of supplier terminals based on the contribution information 1920. Here, the consumer may be a demander terminal that originally requested the generation of the data set, or it can also be a user terminal seeking to purchase an existing data set. Further, the contribution information 1920 may include a contribution rate assigned to each of the plurality of supplier terminals, and the electronic device may distribute the reward based on that assigned contribution rate. In this scenario, the electronic device can record the initial owner of the synthesized data set 1910 (e.g., joint ownership by the data suppliers or ownership entrusted to a server) and the assigned contribution rates of the data suppliers in first block data 1951 of the blockchain network 1950.

Moreover, referring to (b) of FIG. 18, the electronic device can obtain a request for a data transaction S1810. This request may be received from a user terminal seeking to purchase data, but is not limited to such a case; alternatively, the request may be generated automatically when a smart contract condition is fulfilled.

When a predefined criterion is satisfied, the electronic device may execute the data transaction S1820. This predefined criterion can vary depending on the method of data transaction; for instance, it may be set based on whether an agreement related to the data transaction has been reached or whether a preconfigured smart contract condition has been met. The electronic device may mediate data transactions among user terminals, or may sell data directly to a data demander.

For example, referring to FIG. 19, when a predefined criterion is satisfied, the electronic device can transfer the synthesized data set 1910 to the consumer and receive a reward 1940 from the consumer, thereby completing the data transaction 1930. At this time, the reward 1940 may include virtual currency remitted by the consumer and/or virtual currency generated from the blockchain network 1950 on behalf of the consumer.

Referring again to (b) of FIG. 18, the electronic device may transmit the information associated with the data transaction to a blockchain network for storage S1830.

For example, referring to FIG. 19, the electronic device can record transaction information and ownership changes associated with the data transaction 1930 in second block data 1952 of the blockchain network 1950.

Hereinafter, a method of conducting transactions involving a synthesized data set using a blockchain network will be described in detail.

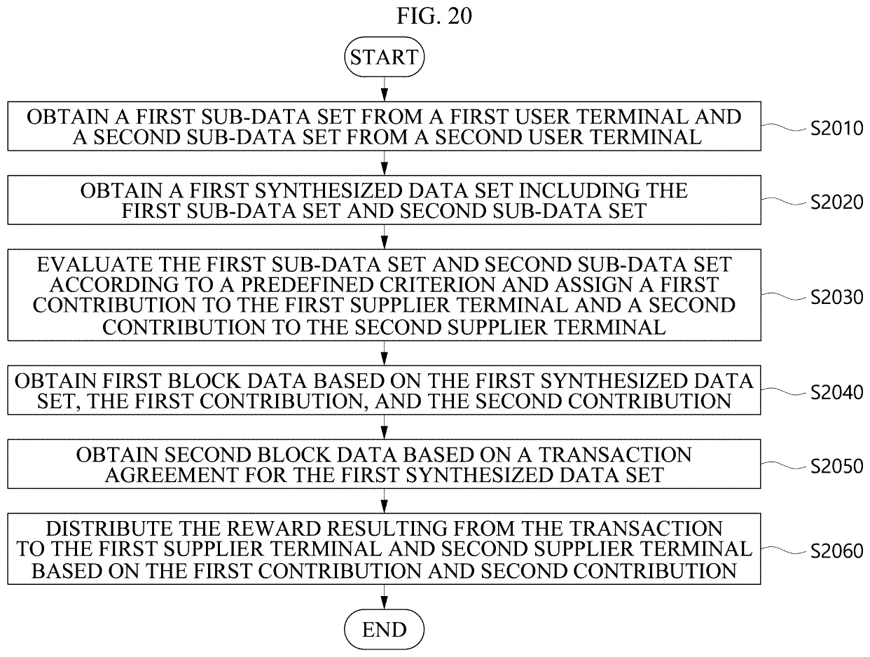

FIG. 20 is a flowchart illustrating a method by which an electronic device conducts transactions involving a synthesized data set—acquired from a supplier terminal—using a blockchain network, according to various embodiments.

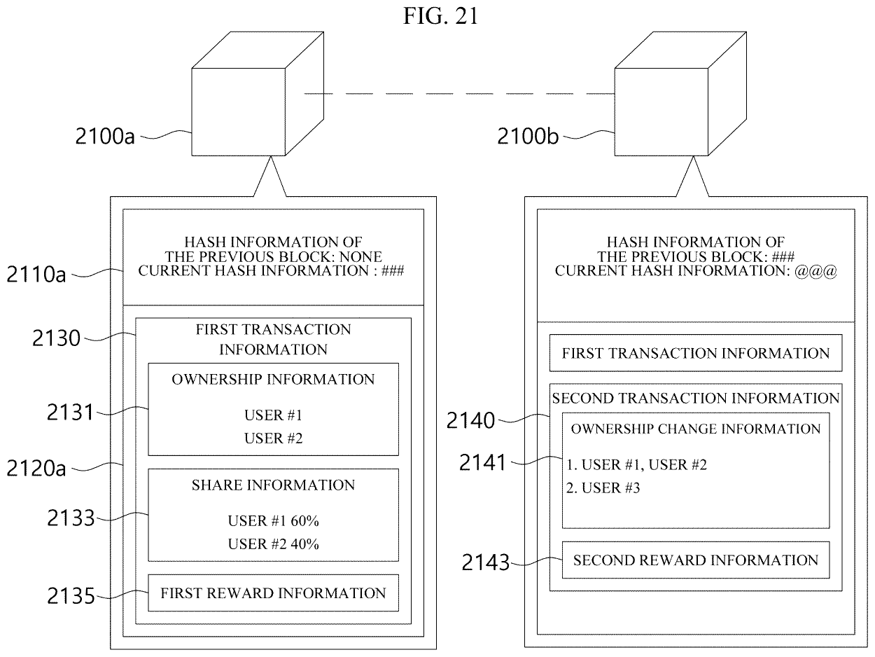

FIG. 21 is a diagram illustrating the information stored in a blockchain network as the electronic device transacts a synthesized data set acquired from a supplier terminal, according to various embodiments.

Referring to FIG. 20, an electronic device (for example, a server) can obtain a first sub-data set from a first user terminal and a second sub-data set from a second user terminal S2010. The electronic device can then obtain a first synthesized data set including the first sub-data set and second sub-data set S2020. Here, the first and second user terminals may be electronic devices assigned the role of data suppliers. The technical features set forth in FIGS. 7 through 17 apply equally to the operations described in steps S2010 and S2020.

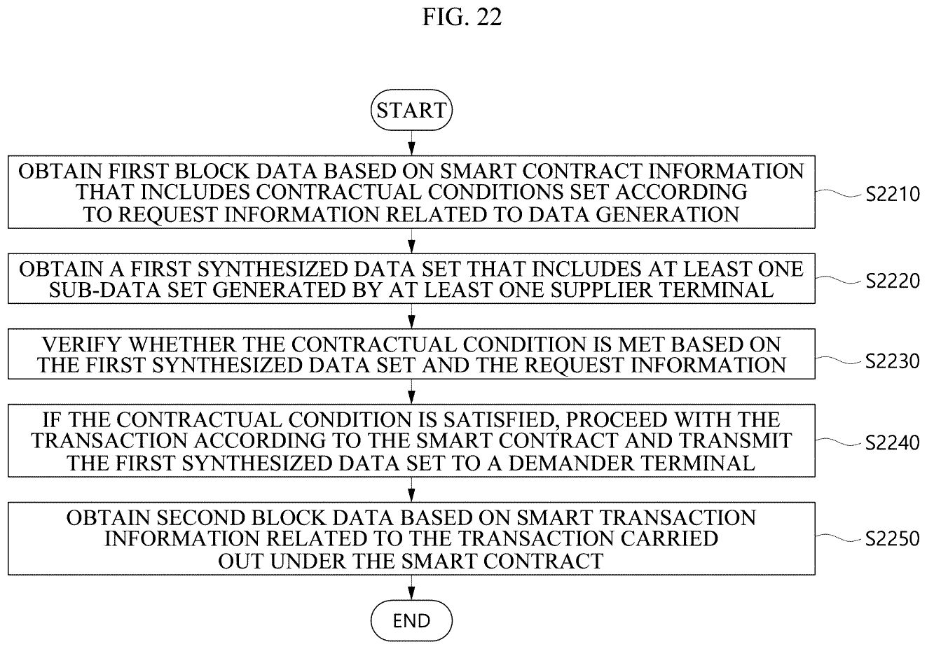

The electronic device may evaluate the first sub-data set and second sub-data set according to a predefined criterion and assign a first contribution to the first supplier terminal and a second contribution to the second supplier terminal S2030. A detailed method for assigning contributions to supplier terminals is explained below with reference to FIG. 22.

Furthermore, the electronic device can obtain first block data based on the first synthesized data set, the first contribution, and the second contribution S2040. Specifically, the electronic device may generate first block data based on the first synthesized data set, the first contribution, and the second contribution, and then transmit it to the blockchain network.

For example, referring to FIG. 21, the electronic device can generate first block data 2100a composed of a HEADER 2110a and a BODY 2110b. Specifically, the electronic device may generate first block data 2100a—containing HEADER 2110a (which includes hash information of the previous block and the current hash information) and BODY 2110b (which includes first transaction information 2130 generated based on the first synthesized data set, the first contribution, and the second contribution)—and then transmit it to the blockchain network. In this context, the first transaction information 2130 may include ownership information 2131 indicating the owner of the first synthesized data set, share information 2133 indicating share ratios among co-owners if the first synthesized data set is jointly owned, and first reward information 2135 indicating any reward disbursed for generating the first synthesized data set.

Here, the ownership information 2131 can contain data about both the current owner and previous owners of the first synthesized data set. If the first synthesized data set is newly generated, at least one user who generated the first synthesized data set may be identified as the initial owner in the ownership information 2131. In addition, if the first synthesized data set is transacted, the ownership information 2131 may include ownership change information regarding the new owner after the transaction. For instance, the ownership information 2131 can indicate a user's ID (e.g., “User #1, User #2”).

Additionally, the share information 2133 may be obtained based on the first contribution and the second contribution. Specifically, by using the first and second contributions—indicating how much each user contributed to generating the first synthesized data set—the electronic device can calculate each user's share ratio and obtain the share information 2133. For example, the share information 2133 might indicate each user's share ratio (e.g., “User #1: 60%, User #2: 40%”). Furthermore, although not shown in FIG. 21, the share information 2133 obtained by the electronic device may include platform contribution information representing the extent to which a platform device contributed to the data's creation. Detailed explanations are provided below (with reference to FIGS. 24-29).

Furthermore, the first reward information 2135 may include a reward associated with creating the first synthesized data set. Specifically, if at least one user terminal generates the first synthesized data set, the electronic device can generate and provide a certain reward in response to the creation of the first synthesized data set. The reward provided may be recorded in the first block data 2100a. Also, the given reward can be distributed to the at least one user based on the share information 2133. For example, in correspondence with the creation of the first synthesized data set, the electronic device may distribute a certain reward to the first user and the second user (e.g., 60% for user #1, 40% for user #2) based on the first and second contributions.

Referring again to FIG. 20, the electronic device may obtain second block data based on a transaction agreement for the first synthesized data set S2050. The transaction agreement may be achieved by approving a transaction request from a third user terminal. The third user terminal in this case can be interpreted as an electronic device acting in the role of a demander that requested the creation of the first synthesized data set, or as a consumer that requested a transaction for the created first synthesized data set.

For instance, the third user terminal may request data generation, prompting creation of the first synthesized data set in response; the third user terminal might then transmit a purchase offer that includes a reward for the generated first synthesized data set. After the electronic device sends an approval of the purchase offer, the transaction agreement is reached. As another example, the third user terminal could request data generation, leading to the creation of the first synthesized data set; in response, the electronic device transmits a sales offer including a reward to the third user terminal, and upon receiving the third user terminal's approval of that sales offer, the transaction agreement is formed. In yet another example, after generating the first synthesized data set, the electronic device may receive a transaction proposal for the created first synthesized data set from the third user terminal, transmit transaction details including a reward in response to that proposal, and then obtain the transaction agreement when an approval for those transaction details is received.

For example, referring to FIG. 21, the electronic device may generate second block data 2100b containing second transaction information 2140 that reflects a transaction agreement for the first synthesized data set, and transmit it to the blockchain network. In this case, the second transaction information 2140 may include ownership change information 2141 that indicates changes in ownership due to the transaction, as well as second reward information 2143 involving any reward accompanying the transaction. For instance, if a transaction for the first synthesized data set is finalized among the first user, the second user, and the third user, the electronic device may create ownership change information 2141 indicating that ownership of the first synthesized data set has shifted from the first and second users to the third user, transmit the first synthesized data set to the third user terminal, and then create the second reward information 2143 based on a specified reward received from the third user terminal. Additionally, the electronic device can generate second block data 2100b—including the first transaction information 2130 and the second transaction information 2140—and transmit it to the blockchain network.

Referring again to FIG. 20, the electronic device may distribute the reward resulting from the transaction to the first supplier terminal and second supplier terminal based on the first contribution and second contribution S2060. For example, referring to FIG. 21, the electronic device can distribute the reward to the first user and the second user based on the share information 2133 stored in the first block data 2100a.

FIG. 22 is a flowchart illustrating a method by which an electronic device provides a data transaction environment based on a smart contract, according to various embodiments.

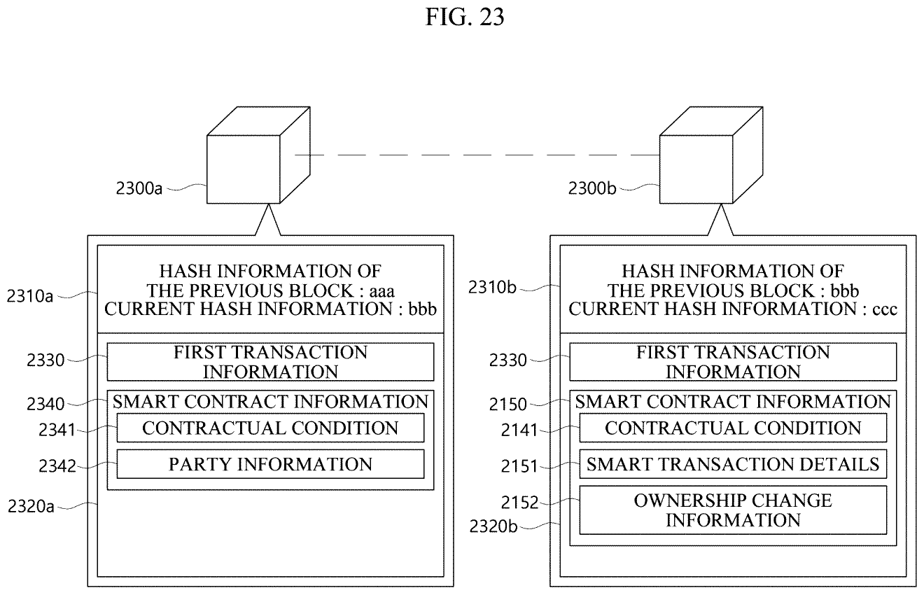

FIG. 23 is a diagram illustrating how block data is generated in a data transaction based on a smart contract, according to various embodiments.

Referring to FIG. 22, an electronic device (e.g., a server) may obtain first block data based on smart contract information that includes contractual conditions set according to request information related to data generation S2210. In this case, the contractual condition may indicate a condition necessary for a smart contract involving the transaction of the first synthesized data set to proceed. Also, the contractual condition may be identical to the data generation condition included in the request information. For instance, the contractual condition can be defined based on the attributes, volume, quality of the synthesized data set that needs to be generated, or its similarity to reference data. Specifically, the electronic device can generate first block data containing smart contract information generated on the basis of these contractual conditions—wherein, if the conditions are fulfilled, the transaction for the first synthesized data set is deemed concluded—and transmit this to the blockchain network.

For example, referring to FIG. 23, the electronic device may create first block data 2300a composed of a HEADER 2310a and a BODY 2320a. The technical features related to the HEADER and BODY in block data are the same as previously described. Additionally, the first block data 2300a that the electronic device generates may include first transaction information 2330 related to the creation and ownership of the first synthesized data set, and smart contract information 2340 associated with the smart contract for the first synthesized data set. A detailed explanation regarding the transaction information is omitted since it was described above. In this context, when a smart contract is set for the first synthesized data set, the electronic device can generate the smart contract information 2340 that includes a contractual condition 2341 associated with the smart contract, as well as party information 2342 for the smart contract. Specifically, the contractual condition 2341 may reflect the requirement under which a transaction for the first synthesized data set will proceed according to the smart contract, and the party information 2342 may indicate both parties to the transaction as specified by the smart contract. Additionally, the contractual condition 2341 may include multiple constraints (e.g., attributes of the synthesized data set, volume, quality, or similarity to reference data) that the first synthesized data set should fulfill.

Referring again to FIG. 22, the electronic device can obtain a first synthesized data set that includes at least one sub-data set generated by at least one supplier terminal S2220. The electronic device may then verify whether the contractual condition is met based on the first synthesized data set and the request information S2230. Specifically, if the data generation condition included in the request information is fulfilled, the electronic device may determine that the contractual condition is satisfied. For instance, referring to FIG. 23, the device can check whether the constraints required by contractual condition 2341 included in the first block data 2300a for the first synthesized data set are met.

Moreover, if the contractual condition is satisfied, the electronic device may proceed with the transaction according to the smart contract and transmit the first synthesized data set to a demander terminal S2240. Specifically, as soon as the first synthesized data set meets the contractual condition, the data transaction under the smart contract may be executed. For instance, once the contractual condition is achieved, the first synthesized data set may be transmitted to the demander terminal, and in response, a reward may be transferred from the demander terminal. In this scenario, the reward transferred by the demander terminal could be transmitted to the electronic device or to the supplier terminal. Additionally, if multiple supplier terminals generated the first synthesized data set, the reward may be distributed based on their respective contributions, although it is not limited to that approach.

Additionally, the electronic device may obtain second block data based on smart transaction information related to the transaction carried out under the smart contract S2250. Specifically, when the contractual condition is met, a smart transaction can be executed according to the smart contract, and the electronic device can create second block data containing the smart transaction information associated with that transaction. The smart transaction information may include details associated with the smart contract and the smart transaction itself.

For example, referring to FIG. 23, the electronic device may generate second block data 2300b composed of HEADER 2310b and BODY 2320b. Specifically, it may include first transaction information 2330, along with smart transaction information 2150 that includes details related to the smart contract and smart transaction. In other words, the smart transaction information 2150 may include not only the smart contract information 2340 included in the first block data 2300a, but also additional information associated with the smart transaction carried out under the smart contract. For instance, the electronic device may reflect the contractual condition 2141 and the party information 2342 included in the smart contract information 2340 to record the smart transaction details 2151, as well as ownership change information 2152 that results from the smart transaction. The disclosure is not limited to these examples, however.

Below is a description of how the timing of generating a synthesized data set relates to the timing of generating block data corresponding to that synthesized data set.

In one embodiment, the electronic device can create block data corresponding to a synthesized data set at the point when at least one user terminal completes the generation of the synthesized data set. In that case, the synthesized data set may be transacted according to the methods described in FIGS. 20 and 21, although the disclosure is not limited to this.

In another embodiment, the electronic device can generate the block data corresponding to the synthesized data set at a predetermined moment before the generation of the synthesized data set is finished. In other words, even if block data corresponding to the synthesized data set is generated, the electronic device may still permit modifications to the synthesized data set.

As one example, the electronic device can generate block data corresponding to the synthesized data set at the time it starts generating the synthesized data set. In this scenario, the synthesized data set may only include a reference data set; the block data corresponding to the synthesized data set may be generated before a supplier terminal to create the data set is determined. Additionally, in this case, the initial owner reflected in the block data's ownership information could be the server (administrator terminal) that manages creation of the synthesized data set.

In another example, the electronic device can generate block data corresponding to a synthesized data set at an arbitrary time while multiple supplier terminals are still generating the synthesized data set. In this scenario, the initial owner reflected in the block data's ownership information may be at least one user terminal participating in the creation of the synthesized data set (in other words, shared ownership among the user terminals that created it).

As mentioned above, if the electronic device generates block data for the synthesized data set at a predetermined time prior to the completion of the data set's creation, the synthesized data set may be transacted according to the smart contracts described in FIGS. 22 and 23, but is not limited thereto. In this case, the electronic device can update the synthesized data set according to data generated by at least one supplier terminal. If, at a certain point, the updated synthesized data set meets the contractual condition, the device can be configured to execute the smart transaction under the smart contract.

Below is an explanation of how to acquire contribution information for a data set created by multiple parties.

FIG. 24 is a diagram illustrating a general method by which an electronic device can obtain contribution information, according to various embodiments.

Referring to FIG. 24, the electronic device can generate contribution information 2400 based on supplier contribution information 2410 and platform contribution information 2420.

Here, the supplier contribution information 2410 may reflect the contribution of data suppliers who directly created the data set. Specifically, the supplier contribution information 2410 may include quality information 2411 reflecting the contribution associated with the quality of the created data, difficulty information 2413 reflecting the contribution associated with the difficulty level of generating the data, and volume information 2415 reflecting the contribution associated with the quantity of data generated.

Additionally, the platform contribution information 2420 may represent the contribution of the platform that provided the environment for generating the data set. Specifically, the platform contribution information 2420 may include reference contribution information 2421 related to the contribution of reference data provided for the synthesized data being generated, generation tool contribution information 2423 related to the contribution of the data generation tool(s) employed in creating the synthetic data, and other tool contribution information 2425 related to the contribution of other tools such as a quality evaluation model or a data imaging tool.

Through this approach, the electronic device can obtain contribution information 2400 in which the contribution of the data suppliers (who directly generated the data) and the platform (that furnished the data creation environment) are both reflected.

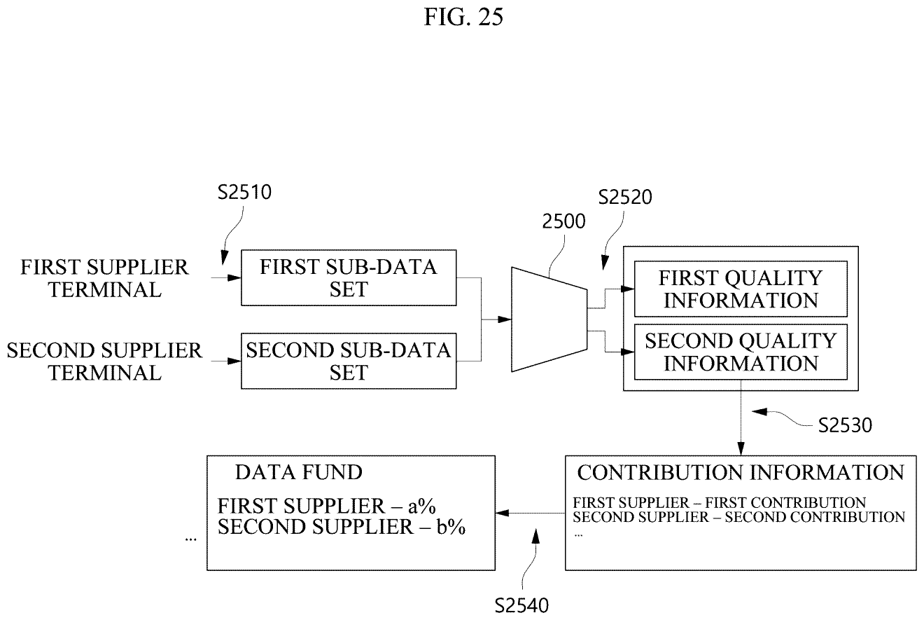

FIG. 25 is a diagram illustrating a method by which an electronic device acquires contribution information based on quality information, according to various embodiments.

Referring to FIG. 25, the electronic device may acquire a first sub-data set from a first supplier terminal and a second sub-data set from a second supplier terminal S2510. Based on the first sub-data set and second sub-data set, the electronic device may obtain a synthesized data set.

Additionally, by inputting the first sub-data set and second sub-data set into a pre-stored quality evaluation model 2500, the electronic device can obtain first quality information corresponding to the first sub-data set and second quality information corresponding to the second sub-data set S2520. Specifically, to determine the contribution of data supplier terminals to the creation of the synthesized data set (which includes the first and second sub-data sets), the electronic device can use the quality evaluation model 2500 based on that synthesized data set to obtain quality information.

In addition, the electronic device can obtain contribution information based on the first and second quality information S2530. Specifically, the electronic device may generate contribution information by assigning a first contribution to a first supplier and a second contribution to a second supplier, using the first quality information and the second quality information. Here, the contribution information can include not only the contribution of each supplier but also the contribution of the platform that provides the environment for generating the synthesized data set. For instance, if the quality of the first sub-data set created by the first supplier (as determined by the first quality information) is higher than the quality of the second sub-data set created by the second supplier (as determined by the second quality information), the electronic device can assign a higher contribution to the first supplier, thereby generating the contribution information.

Furthermore, the electronic device can create a data fund based on the contribution information S2540. In this context, the data fund may be an intangible asset that defines the ownership shares of the synthesized data set, based on the contribution. Specifically, according to the share ratios determined by the data fund, multiple suppliers can co-own the synthesized data set. By building such a data fund as described above, the electronic device can store ownership information about the synthesized data set and distribute rewards—should they arise from the creation or transaction of the synthesized data set—based on the data fund.

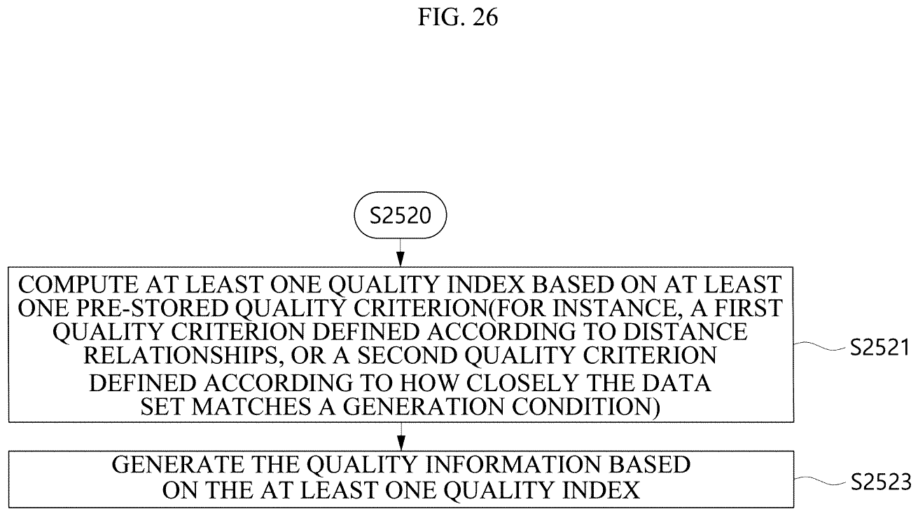

FIG. 26 is a diagram illustrating a method by which an electronic device generates quality information about a created data set, according to various embodiments.

Referring to FIG. 26, in order to acquire quality information at step S2520 of FIG. 25, the electronic device can compute at least one quality index based on at least one pre-stored quality criterion(for instance, a first quality criterion defined according to distance relationships, or a second quality criterion defined according to how closely the data set matches a generation condition) S2521.

Specifically, the electronic device can identify the distance relationships among the data points included in the data set and derive a quality index related to distance from those relationships. For instance, by computing the distance among data points contained in the data set, the electronic device may determine at least one factor among the data set's density, bias, or uniformity of distribution. Furthermore, the electronic device can calculate a distance-related quality index of the data set based on its density, bias, or uniformity of distribution. As a concrete example, the device may conclude that the distance-related quality index is higher if the data set exhibits uniform density, minimal bias, and a uniform distribution. Additionally, for example, the electronic device can compute a quality index associated with condition conformance, based on the extent to which the generated data set meets the requested generation condition. Specifically, the device may determine that the closer the data set aligns with the generation condition, the higher the associated quality index.

Additionally, the electronic device can generate the quality information based on the at least one quality index S2523.

By evaluating the quality of the data created by each supplier in this manner, the electronic device can assign contributions to suppliers according to the quality of their respective data, thereby obtaining supplier contribution information.

Furthermore, this is not the only approach: as shown in FIG. 24, the electronic device can also take into account difficulty information and volume information to derive supplier contribution information. Specifically, the electronic device can assign a higher contribution to a supplier who generated data with a higher difficulty level, and also assign a higher contribution to a supplier who generated data in larger volumes.

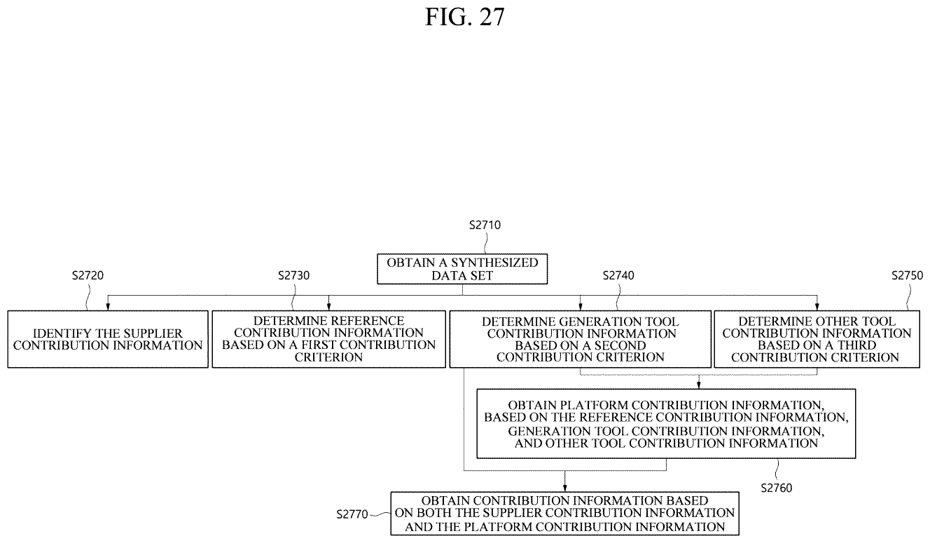

FIG. 27 is a flowchart illustrating a method by which an electronic device acquires platform contribution information, according to various embodiments.

Referring to FIG. 27, the electronic device can obtain a synthesized data set from at least one supplier terminal S2710.

Additionally, the electronic device can identify the supplier contribution information based on the synthesized data set S2720. Here, specific methods for confirming the supplier contribution information may directly apply from those described in FIGS. 25 and 26.

Moreover, the electronic device can determine reference contribution information based on a first contribution criterion S2730. For instance, the first contribution criterion may be configured based on at least one of the following: the proportion occupied by the reference data set within the synthesized data set, the size of the reference data set, the quality of the reference data set, or the similarity between the synthesized data set and the reference data set. Specifically, the electronic device may assign a higher contribution for the reference data set in the reference contribution information if the reference data set constitutes a larger portion of the synthesized data set, if its size is larger, if its quality is higher, or if its similarity to the synthesized data set is greater.

Additionally, the electronic device can determine generation tool contribution information based on a second contribution criterion S2740. For instance, the second contribution criterion may be set based on at least one of the following: whether a generation tool is used, the properties of the generation tool used (e.g., whether it is a high-quality generative model or a generation tool requiring high construction cost), the usage frequency of the generation tool, or the number of generation tools employed. Specifically, the electronic device may allocate a higher contribution for the generation tool in the generation tool contribution information if a high-quality generation tool is used frequently to generate the synthesized data set or if a wide variety of generation tools are used.

Additionally, the electronic device may determine other tool contribution information based on a third contribution criterion S2750. For example, the third contribution criterion may apply in cases where other tools (such as a data imaging tool or a quality evaluation tool) are utilized. Specifically, if such other tools are used in the process of generating a synthesized data set, a certain contribution attributed to the use of those tools can be allocated as other tool information.

Moreover, the electronic device can obtain platform contribution information, based on the reference contribution information, generation tool contribution information, and other tool contribution information S2760. The electronic device can then obtain contribution information based on both the supplier contribution information and the platform contribution information S2770.

Here, the electronic device may generate platform contribution information for each of the at least one supplier terminal. Specifically, it can calculate the platform contribution for each supplier according to the extent to which that supplier terminal has utilized the platform environment.

Moreover, the electronic device may distribute rewards while considering the platform contribution information. Specifically, it can distribute rewards generated from the creation or transaction of the synthesized data based on supplier contribution information, and determine the final reward for each supplier by taking into account the platform contribution information. For example, the electronic device can determine the final reward by subtracting a platform fee (calculated based on the platform contribution information) from the reward allocated to each supplier. As a specific example, the electronic device may initially distribute a first reward to the first supplier, and after accounting for the platform contribution of the first supplier, provide a second reward to that supplier by subtracting the platform fee from the first reward.

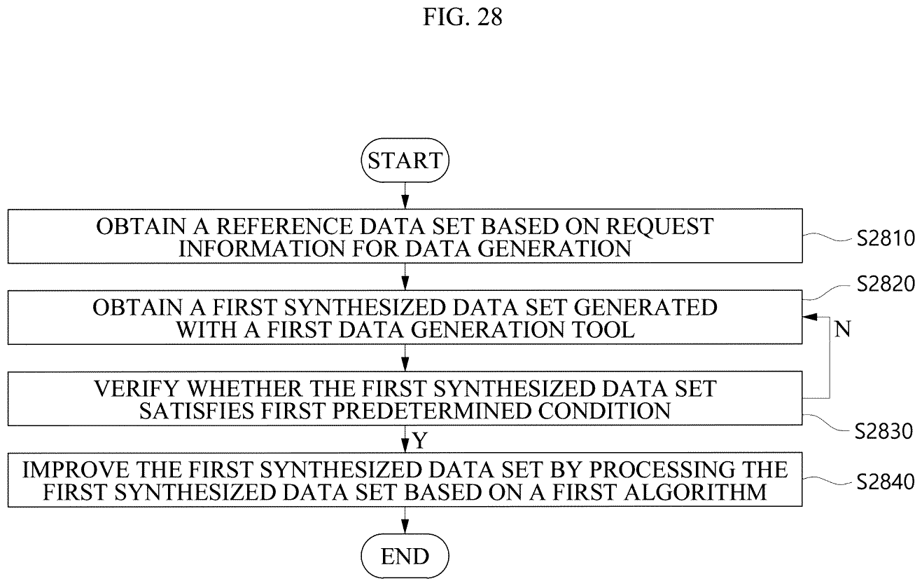

FIG. 28 is a diagram illustrating a data improvement method of an electronic device that provides a platform, according to various embodiments.

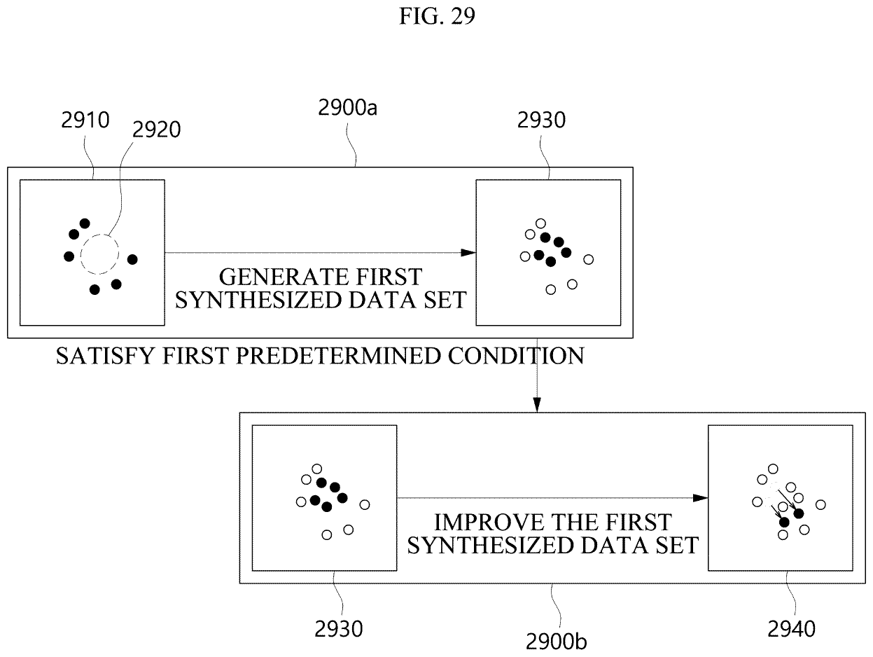

FIG. 29 is a diagram illustrating how an electronic device that provides a platform may acquire platform contribution information through the process of improving data, according to various embodiments. Although reference numerals 2910, 2930, and 2940 in FIG. 29 are illustrated as data images by way of example, they may also represent actual data.

Referring to FIG. 28, according to one embodiment, an electronic device can obtain a reference data set based on request information for data generation S2810. The electronic device can also obtain a first synthesized data set generated with a first data generation tool S2820. For example, referring to FIG. 29, a first electronic device 2900a can acquire a reference data set 2910 that includes a visual indicator 2920 corresponding to the request information. For instance, the first electronic device 2900a may be a data supplier terminal that has received the reference data set reflecting the request information. In this scenario, the supplier terminal may generate data based on the reference data set 2910 in response to the request information. Consequently, the first synthesized data set 2930 can be obtained from the reference data set 2910.

Referring back to FIG. 28, the electronic device can verify whether the first synthesized data set satisfies first predetermined condition S2830. This first predetermined condition may be established based on the first synthesized data set and the request information. Specifically, if the first synthesized data set achieves a generation condition included in the request information to at least a predefined threshold, the electronic device may conclude that the first predetermined condition is satisfied.

For example, referring to FIG. 29, the first predetermined condition may be configured based on the amount of data created by the supplier that corresponds to the generation condition. Additionally, the first predetermined condition can be set based on the ratio of data generated within a visual indicator 2920 that reflects the request information. For instance, a second electronic device 2900b could decide that the first predetermined condition is satisfied if the amount of data or the ratio of data corresponding to the generation condition in the first synthesized data set is greater than a threshold. For example, the second electronic device 2900b can be a server that determines whether the synthesized data set satisfies the required condition.

If the first synthesized data set does not satisfy the first predetermined condition, the synthesized data set can be recreated by repeating the operation in step S2820.

Moreover, referring again to FIG. 28, if the first synthesized data set satisfies the first predetermined condition, the electronic device may improve the first synthesized data set by processing the first synthesized data set based on a first algorithm S2840. Here, data “improvement” refers to modifying or deleting certain data within the data set, or generating additional data.

Specifically, the first algorithm is designed to improve the first synthesized data set, and the operational procedure of the electronic device (processor) is as follows:

The electronic device can map the first synthesized data set to a first embedding space to generate a first data point set. The first data point set may reflect the distribution of the first synthesized data set. Concretely, each piece of data in the synthesized data set can correspond to each data point in the first data point set. Additionally, by displaying the first data point set in an imaging space, the electronic device can acquire a first data image corresponding to the first synthesized data set.

After generating the first data point set, the electronic device can obtain a first improved data point set by adjusting the properties of at least some of the data points in the first data point set. The properties of a data point may include, among other aspects, the number of data points, their positions in the embedding space, or the distance between data points. For example, the electronic device may obtain the first improved data point set by modifying the positions in the first embedding space of at least some of the multiple data points included in the first data point set. Additionally, for instance, the electronic device might obtain the first improved data point set by adding certain data points to the first data point set.

After generating the first improved data point set, the electronic device can obtain a first improved synthesized data set based on the first improved data point set. Specifically, the electronic device can generate the first improved synthesized data set by using a pre-stored generative model. For example, it may decode the first improved data point set, which is defined in the first embedding space, back into the input space to generate the first improved synthesized data set, but it is not limited thereto. By adjusting the properties of data in the embedding space, the first improved synthesized data set can differ from the first synthesized data set (for instance, with higher quality data, or data with a larger volume).

For example, referring to FIG. 29, if the first synthesized data set 2930 satisfies the first predetermined condition, a second electronic device 2900b may generate a first improved synthesized data set 2940 based on the first synthesized data set.

Additionally, if this second electronic device is a platform-providing device (e.g., a server or administrator terminal), it can obtain platform contribution information. Specifically, the second electronic device may obtain the platform contribution information based on the first synthesized data set 2930 and the first improved synthesized data set 2940. Concretely, the second electronic device can reflect how much the data was improved according to the reference data set 2910's contribution and the first algorithm used to generate the first improved synthesized data set 2940, thereby obtaining the platform contribution information. For example, the second electronic device 2900b may send a final reward to the first electronic device 2900a, after subtracting a fee for the improvement, from any reward gained via the generation or transaction of the first improved synthesized data set.

### Data-Utilization Environment

According to various embodiments of the present disclosure, an electronic device can provide a data-utilization environment in which a data set (e.g., a synthetic data set) can be exploited in multiple ways.

The following describes several embodiments in which data sets that are generated or transacted through the platform environment are utilized within that same platform environment.

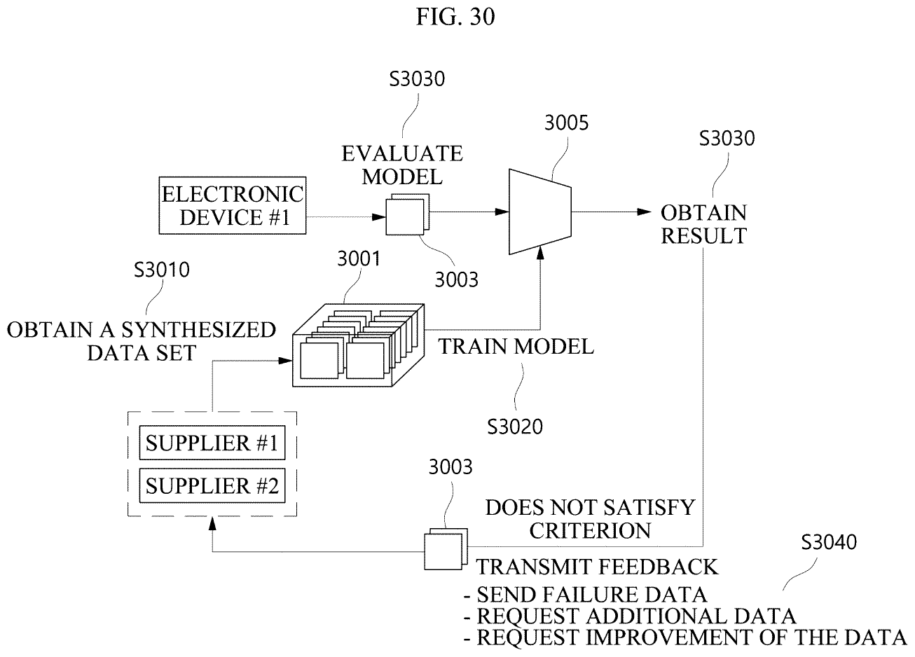

FIG. 30 is a diagram illustrating a method by which an electronic device provides feedback on data generation using a reference model, according to various embodiments.

Referring to FIG. 30, a platform-providing device (e.g., a server) may obtain a synthesized data set 3001 (S3010). The server can receive the synthesized data set 3001 generated by at least one supplier terminal.

The server may train a reference model 3005 on the basis of the synthesized data set 3001 (S3020). The reference model 3005 may be a pre-stored AI model (e.g., a deep-learning model or neural-network model). For example, the server can train a waste-plastic classification model using a synthesized data set on waste plastics obtained from at least one supplier terminal.

The server may evaluate the trained reference model 3005 and obtain an evaluation result (S3030). Specifically, to determine whether the trained reference model 3005 works well in real situations, the server performs an evaluation. For example, the server may obtain an evaluation data set 3003 from a first electronic device, input the evaluation data set into the trained reference model 3005 to obtain an output, and then assess the model's performance on the basis of that output. The evaluation data set 3003 may be data collected by the first electronic device—for instance, images of objects in the same domain as the synthesized data set 3001 (e.g., waste-plastic images) captured by the first electronic device, or data arbitrarily generated in that same domain.

If the output produced by the reference model 3005 for the evaluation data set 3003 does not satisfy a predetermined criterion, the server may transmit feedback regarding the result to the at least one supplier terminal (S3040). For instance, the server may send failure data to the supplier terminal, request additional data to overcome the failure case, or request improvement of the generated data. Concretely, the server can transmit the evaluation data set 3003 itself as failure data and request additional synthesized data related to it—for example, by sending a message that asks for data similar to the evaluation data set 3003.

The feedback may further include a range of generation parameters—parameters used by the data-generation tool to create synthetic data associated with the evaluation data set. Specifically, the server can provide the parameter range that should be applied to the data-generation tool in order to generate data similar to the evaluation data set.

During training and evaluation of the reference model using training data, unsuitable results can arise due to differences in the environment where the data were collected. A typical example is in autonomous-driving imagery: a solution trained on images collected in Country A may not yield appropriate results when fed images collected in Country B.

To resolve this, an electronic device according to one embodiment can provide feedback for domain adaptation during reference-model training. Specifically, the device may deploy a reference model trained on a data set collected in a first environment to a device used in a second environment, and perform adaptation from the first domain to the second domain. For example, the device may generate data of the second environment based on data collected in the first environment, or transmit feedback to at least one supplier terminal requesting generation of synthetic data associated with the second environment.

The at least one supplier terminal can then generate a synthesized data set based on the received feedback.

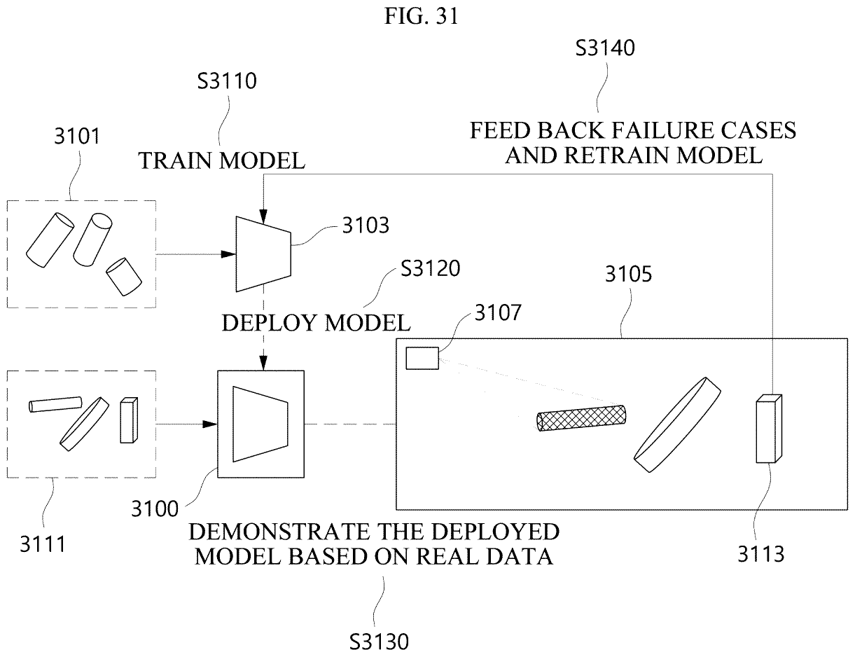

FIG. 31 is a diagram illustrating a method by which an electronic device trains and demonstrates a waste-plastic classification model, according to various embodiments.

Referring to FIG. 31, the electronic device may train a reference model 3103 on the basis of a first synthesized data set 3101 (S3110). The first synthesized data set 3101 may be an image data set in the waste-plastic domain, but is not limited thereto. The reference model 3103 may be an AI model that classifies waste plastic according to predefined criteria, though it is not limited thereto. For example, data related to waste plastic that are input to the reference model 3103 can be classified into one or more classes based on contamination level, crumple degree, label presence, and so forth. In another example, the reference model 3103 may determine which waste plastics are recyclable. Concretely, the electronic device can input a plastic image into the reference model and decide whether the depicted plastic is recyclable.

The electronic device may deploy the trained reference model 3103 to the platform environment (S3120). Deployment to the platform environment means making the reference model available so that platform users can demonstrate it.

Additionally, the electronic device can deploy the trained reference model 3103 to a real-world environment where tasks are performed using the model.

At least one user terminal within the platform environment can demonstrate the deployed reference model 3103 based on real data (S3130). Specifically, the user terminal may input an evaluation data set 3111 to the reference model 3103 to verify whether a solution 3100 built on the model operates properly.

In this case, the electronic device can demonstrate the solution 3100—based on the reference model 3103—through a predefined output environment 3105 (either an in-platform demo space or an operational workspace). The predefined output environment may be a simulation area within the platform, or a real-world work environment.

Concretely, the electronic device can output the evaluation data set 3111 to the output environment 3105 and display the results of the solution 3100—based on the reference model 3103—via at least one output device 3107. For example, if the solution 3100 is a device that determines recyclable waste plastic via the reference model 3103, the output device 3107 can display data identified as recyclable in the output environment 3105. As a concrete example, the output device 3107 may include an AR projector that projects a visual effect onto recyclable plastic data 3112, allowing users who demonstrate or employ the solution 3100 to visually confirm recyclable plastics.

The electronic device can feed back failure cases occurring during the demonstration and retrain the reference model 3103 (S3140). Specifically, by additionally training on failure cases observed in the platform demonstration, the device can optimize the reference model. For instance, if a device fails to classify recyclable plastic for certain plastic data 3113, the electronic device may store that data as a failure case, retrain the reference model 3103 on the basis of the data 3113, generate additional synthetic data similar to it, and retrain the model again with the generated data.

Additionally, the electronic device may transmit feedback to at least one data-supplier terminal, requesting generation of additional data related to the reference model's failure cases.

Below, an embodiment is described in which the electronic device generates a synthesized data set related to outlier data and uses it to train and demonstrate a model for detecting outliers.

Here, outlier data are the opposite concept to normal data.

Normal data refer to typical data in a given domain—for example, plastic images in the plastic domain, or bank-transfer records within a normal range in the financial-transaction domain.

Outlier data are data that are atypical, peculiar, abnormal, or inappropriate in the domain. For instance, in the plastic domain, an image without any plastic can be an outlier; in the financial domain, a transfer record beyond the normal range or a record potentially linked to crime can be an outlier.

Especially for financial data, accurately detecting outliers is crucial for uncovering phishing crimes, tax evasion, and similar activities.

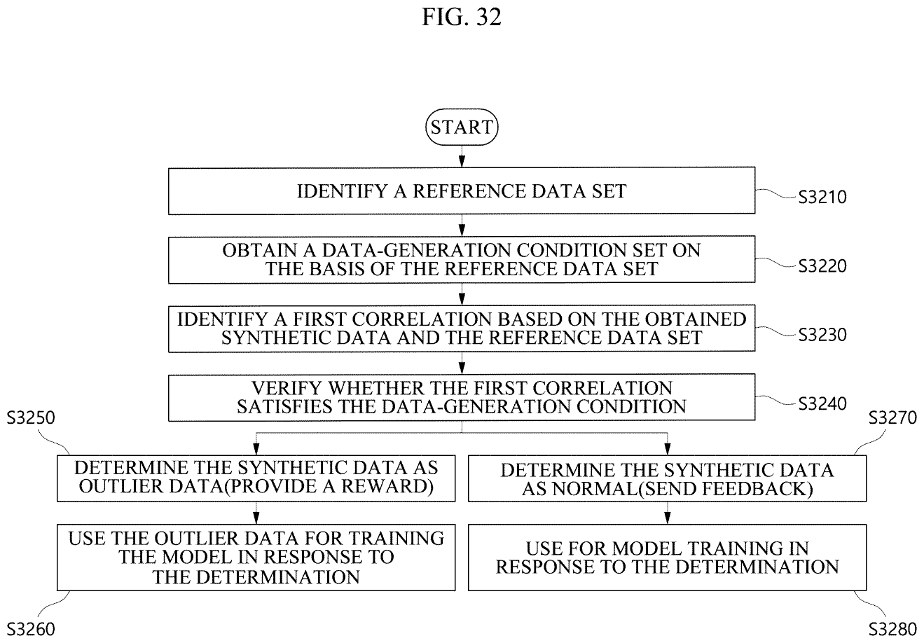

FIG. 32 is a flowchart illustrating a data-construction method for training a model that detects outlier data, according to various embodiments.

Referring to FIG. 32, the electronic device may identify a reference data set S3210. The reference data set may be pre-stored in the device and may consist of normal data distinguished from outliers; hence it can serve as normal data for training an outlier-detection model.

The electronic device can obtain a data-generation condition set on the basis of the reference data set S3220. The condition may be defined according to the relationship—e.g., similarity distance—between generated data and the reference data set. For example, the device may set a threshold such that any data whose similarity to the normal reference set is below that threshold satisfy the generation condition, though other definitions are possible.

The electronic device may provide the generation condition to at least one data-supplier terminal, which can then acquire synthetic data in accordance with the condition (not shown).

Next, the electronic device may identify a first correlation based on the obtained synthetic data and the reference data set S3230. Specifically, it may compute similarity—based on distance—between the synthetic data and the reference data set, thereby identifying the first correlation. For example, the electronic device can calculate the distance between the acquired synthetic data and the reference data set, thereby identifying a first correlation that reflects the similarity between the synthetic data and the reference data set.

The electronic device can verify whether the first correlation satisfies the data-generation condition S3240.

If the first correlation satisfies the condition, the electronic device may determine the synthetic data as outlier data S3250. Also, in this case, the electronic device may provide a reward to the supplier terminal that generated the data for satisfying the condition.

The device can also use the outlier data for training the model in response to the determination S3260.

If the first correlation does not satisfy the condition, the device may determine the synthetic data as normal S3270. Also, in this case, the electronic device may send feedback to the supplier terminal indicating non-conformance with the generation condition.

The electronic device may also use the synthetic data for model training in response to the determination S3280.

A model trained by the above method can be supplied to data providers as a tool for verifying outliers, or used to detect abnormal data in a specific domain.

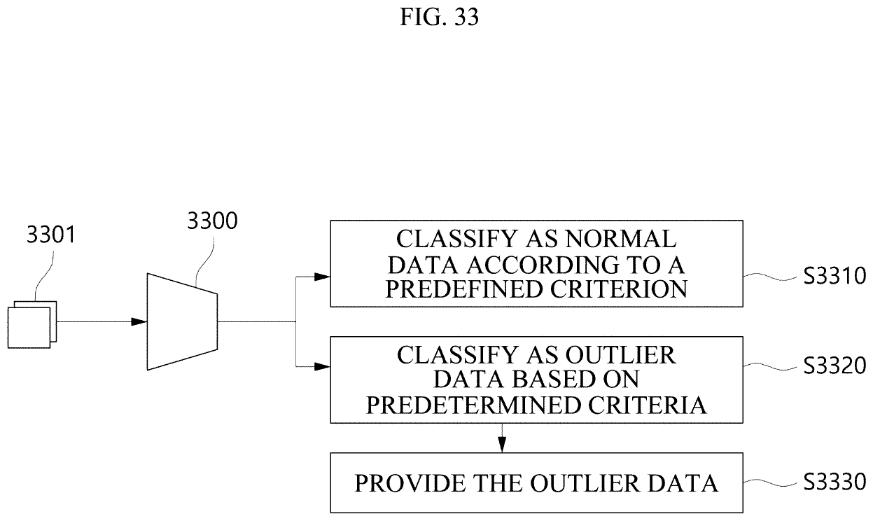

FIG. 33 is a diagram illustrating a method by which an electronic device demonstrates an outlier-detection model, according to various embodiments.

Referring to FIG. 33, the electronic device can input an evaluation data set 3301 into a first AI model 3300 that detects outliers.

Depending on the model's output, the device may classify the evaluation data set 3301 as normal data according to a predefined criterion S3310.

Further, based on the output from said first artificial intelligence model 3300, the electronic device may classify the evaluation data set 3301 as outlier data based on predetermined criteria S3320. At this point, the electronic device may provide the outlier data S3330.

For instance, a user terminal may input a first data set related to financial transactions into the electronic device containing the AI model 3300. If the device determines—under a preset criterion—that the data set is a normal transaction, it may output “normal” to the user terminal or output nothing. If the data set is judged abnormal (e.g., a suspicious or illicit transfer), the device outputs that result to the user terminal.

The methods according to the embodiments can be implemented as program instructions that are executed by various computer means and recorded on a computer-readable medium. The computer-readable medium may include, alone or in combination, program instructions, data files, and data structures. The program instructions recorded on the medium may be specially designed and configured for the embodiments, or they may be usable by those skilled in computer software. Examples of computer-readable recording media include magnetic media such as hard disks, floppy disks, and magnetic tape; optical media such as CD-ROMs and DVDs; magneto-optical media such as floptical disks; and hardware devices specially configured to store and execute program instructions, such as ROM, RAM, and flash memory. Examples of the program instructions include machine code, such as that produced by a compiler, as well as high-level language code that can be executed by a computer using an interpreter or the like. The aforementioned hardware devices may be configured to operate as one or more software modules for performing the operations of the embodiments, and vice versa.

While the embodiments have been described above with reference to limited examples and figures, those skilled in the art will appreciate that various modifications and alterations can be made based on the foregoing disclosure. For example, the technologies described herein can be performed in a different order than described, and/or components of the described system, structure, device, or circuit may be combined or arranged differently than described, or replaced or substituted by other components or their equivalents, while still achieving desired outcomes.

Therefore, other implementations, embodiments, and equivalents to the following claims are also within the scope of the appended claims.

1. A method for providing a virtual environment in which at least one data provider terminal can generate data, the method comprising, by at least one processor of an electronic device:
obtaining a request for generation of a data set;
identifying a reference data set pre-stored in a memory based on the request;
obtaining a first request information including a first generation condition which is set based on a relationship with the reference data set, and providing a first virtual environment for data generation based on the first request information;
determining whether a first synthesized data set, generated by at least one user terminal that accesses the first virtual environment, satisfies the first generation condition; and
based on a determination result that the first synthesized data set satisfies the first generation condition, blocking user access to the first virtual environment.

2. The method of claim 1, wherein the request includes at least one of attributes of the data set, a quality of the data set, or a sample data, wherein the attributes of the data set include a domain of data and a modality of data.

3. The method of claim 1, wherein identifying the reference data set comprises:
searching, among a plurality of reference data sets pre-stored in the memory, for a reference data set corresponding to the request.

4. The method of claim 1, wherein the first generation condition is set based on a similarity with the reference data set.

5. The method of claim 2, wherein the first request information includes the first generation condition, the reference data set, and the sample data.

6. The method of claim 1, further comprising:
after providing the first virtual environment, obtaining level information indicating level of data to be generated based on the first request information;
selecting a first data provider corresponding to the level information; and
providing information about the first virtual environment to a first user terminal corresponding to the selected first data provider.

7. The method of claim 1, wherein determining whether the first generation condition is satisfied comprises:
identifying a similarity between the first synthesized data set and the reference data set; and
determining whether the similarity corresponds to the first generation condition.

8. The method of claim 1, further comprising:
obtaining a second generation condition which is set based on a relationship with the reference data set, wherein the first generation condition is set based on a first correlation with the reference data set, and the second generation condition is set based on a second correlation with the reference data set.

9. The method of claim 8, further comprising:
providing the first generation condition to a second user terminal that accesses the first virtual environment, and providing the second generation condition to a third user terminal that accesses the first virtual environment.

10. The method of claim 1, further comprising:
based on a determination that the first synthesized data set does not satisfy the first generation condition, requesting additional data generation from the at least one user terminal.

11. The method of claim 10, further comprising:
obtaining an improved synthesized data set based on a second synthesized data set additionally generated by the at least one user terminal.

12. The method of claim 1, wherein providing the first virtual environment comprises:
selecting a portion of a plurality of data generation tools stored in the memory based on the first request information.

13. The method of claim 1, wherein blocking user access to the first virtual environment comprises:
storing the first synthesized data set in the memory.

14. A non-transitory computer-readable recording medium having recorded thereon a program for causing a processor to execute the method of claim 1.

15. A system comprising:
a server configured to perform the method of claim 1; and
a second electronic device configured to access the first virtual environment provided by the server and generate the first synthesized data.
